(19) United States
(12) Patent Application Publication
(10) Pub. No.: US 2024/0046118 A1
(43) Pub. Date: Feb. 8, 2024

(54) INFORMATION PROCESSING SYSTEM, INFORMATION PROCESSING METHOD, AND COMPUTER PROGRAM

(71) Applicant: NEC Corporation, Minato-ku, Tokyo (JP)

(72) Inventors: Akinori Ebihara, Tokyo (JP); Taiki Miyagawa, Tokyo (JP)

(73) Assignee: NEC Corporation, Minato-ku, Tokyo (JP)

(21) Appl. No.: 18/269,499

(22) PCT Filed: Dec. 28, 2020
(86) PCT No.: PCT/JP2020/049170

§ 371 Date: Jun. 23, 2023

(51) Int. Cl. G06N 5/022

(52) U.S. Cl. CPC G06N 5/022

(57) ABSTRACT

An information processing system includes: an acquisition unit that obtains a plurality of elements included in series data; a calculation unit that calculates a likelihood ratio indicating a likelihood of a class to which the series data belong, on the basis of at least two consecutive elements of the plurality of elements: a classification unit that classifies the series data into at least one class, on the basis of the likelihood ratio; and a learning unit that performs learning related to calculation of the likelihood ratio, by using a plurality of series data. The learning unit changes a degree of contribution to the learning of each of the plurality of series data in accordance with ease of classification of the series data. According to such an information processing system, it is possible to properly perform the learning related to the calculation of the likelihood ratio.

### TECHNICAL FIELD

This disclosure relates to an information processing system, an information processing method, and a computer program that process information about class classification, for example.

### BACKGROUND ART

A known system of this type performs a learning process about class classification. For example, Patent Literature 1 discloses that when learning images are classified, a value that allows a minimum total number of failures is searched for and determined. Patent Literature 2 discloses that learning is performed in advance by using time series data, on a classification apparatus that uses a logarithm likelihood.

As another related technology, for example, Patent Literature 3 discloses a technique/technology of calculating a likelihood ratio and performing a spoofing determination. Patent Literature 4 discloses a technique/technology in which when an authentication time is greater than or equal to a predetermined time on an apparatus that verifies a face image, it is determined that the registered image is an image that is hardly authenticated, and an update flag is turned on.

### CITATION LIST

### Patent Literature

Patent Literature 1: JP2009-086749A
Patent Literature 2: JP2009-245314A
Patent Literature 3: JP2009-289253A
Patent Literature 4: JP2012-208610A

### SUMMARY

### Technical Problem

This disclosure aims to improve the related techniques/technologies described above.

### Solution to Problem

An information processing system according to an example aspect of this disclosure includes: an acquisition unit that obtains a plurality of elements included in series data; a calculation unit that calculates a likelihood ratio indicating a likelihood of a class to which the series data belong, on the basis of at least two consecutive elements of the plurality of elements: a classification unit that classifies the series data into at least one class, on the basis of the likelihood ratio; and a learning unit that performs learning related to calculation of the likelihood ratio, by using a plurality of series data, wherein the learning unit changes a degree of contribution to the learning of each of the plurality of series data in accordance with ease of classification of the series data.

An information processing method according to an example aspect of this disclosure includes: obtaining a plurality of elements included in series data; calculating a likelihood ratio indicating a likelihood of a class to which the series data belong, on the basis of at least two consecutive elements of the plurality of elements: classifying the series data into at least one class, on the basis of the likelihood ratio; performing learning related to calculation of the likelihood ratio, by using a plurality of series data; and when performing the learning, changing a degree of contribution to the learning of each of the plurality of series data in accordance with ease of classification of the series data.

A computer program according to an example aspect of this disclosure operates a computer: to obtain a plurality of elements included in series data; to calculate a likelihood ratio indicating a likelihood of a class to which the series data belong, on the basis of at least two consecutive elements of the plurality of elements: to classify the series data into at least one class, on the basis of the likelihood ratio; to perform learning related to calculation of the likelihood ratio, by using a plurality of series data; and when performing the learning, to change a degree of contribution to the learning of each of the plurality of series data in accordance with ease of classification of the series data.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of a classification apparatus in the information processing system according to the first example embodiment.

FIG. 4 is a flowchart illustrating a flow of operation of a learning unit in the information processing system according to the first example embodiment.

FIG. 5 is a flowchart illustrating a flow of operation of the learning unit in an information processing system according to a second example embodiment.

FIG. 6 is a flowchart illustrating a flow of operation in a first modified example of the learning unit in the information processing system according to the second example embodiment.

FIG. 7 is a flowchart illustrating a flow of operation in a second modified example of the learning unit in the information processing system according to the second example embodiment.

FIG. 8 is a flowchart illustrating a flow of operation of a learning unit in an information processing system according to a third example embodiment.

FIG. 9 is a flowchart illustrating a flow of operation in a first modified example of the learning unit in the information processing system according to the third example embodiment.

FIG. 10 is a flowchart illustrating a flow of operation in a second modified example of the learning unit in the information processing system according to the third example embodiment.

FIG. 11 is a flowchart illustrating a flow of operation of the learning unit when information processing systems according to the second example embodiment and the third example embodiment are combined.

FIG. 12 is a flowchart illustrating a flow of operation of a learning unit in an information processing system according to a fourth example embodiment.

FIG. 13 is version 1 of a table illustrating an example of setting a learning contribution degree by the learning unit in the information processing system according to the fourth example embodiment.

FIG. 14 is version 2 of a table illustrating an example of setting the learning contribution degree by the learning unit in the information processing system according to the fourth example embodiment.

FIG. 15 is version 3 of a table illustrating an example of setting the learning contribution degree by the learning unit in the information processing system according to the fourth example embodiment.

FIG. 16 is a block diagram illustrating a functional configuration of an information processing system according to a fifth example embodiment.

FIG. 17 is a flowchart illustrating a flow of operation of a likelihood ratio calculation unit in the information processing system according to the fifth example embodiment.

FIG. 18 is a flowchart illustrating a flow of operation of a learning unit in the information processing system according to the fifth example embodiment.

FIG. 19 is a graph illustrating an example of a likelihood ratio used for learning in the information processing system according to the fifth example embodiment.

FIG. 20 is a flowchart illustrating a flow of operation of a learning unit in an information processing system according to a sixth example embodiment.

FIG. 21 is a graph illustrating an example of a likelihood ratio used for the learning in the information processing system according to the sixth example embodiment.

FIG. 22 is a flowchart illustrating a flow of operation of a learning unit in an information processing system according to a seventh example embodiment.

FIG. 23 is a graph illustrating an example of a likelihood ratio used for the learning in the information processing system according to the seventh example embodiment.

FIG. 24 is a flowchart illustrating a flow of operation of a learning unit in an information processing system according to an eighth example embodiment.

FIG. 25 is version 1 of a graph illustrating an example of a likelihood ratio used for the learning in the information processing system according to the eighth example embodiment.

FIG. 26 is version 2 of a graph illustrating an example of the likelihood ratio used for the learning in the information processing system according to the eighth example embodiment.

FIG. 27 is a graph illustrating an example of a likelihood ratio used for the learning in an information processing system according to a ninth example embodiment.

### DESCRIPTION OF EXAMPLE EMBODIMENTS

Hereinafter, an information processing system, an information processing method, and a computer program according to example embodiments will be described with reference to the drawings.

### First Example Embodiment

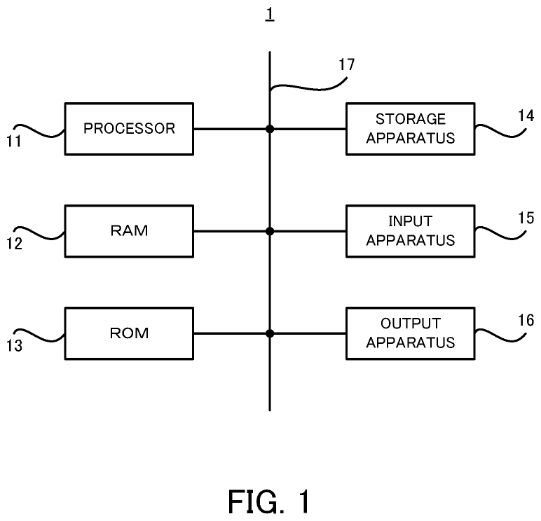

An information processing system according to a first example embodiment will be described with reference to FIG. 1 to FIG. 4.

### (Hardware Configuration)

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, an information processing system 1 according to the first example embodiment includes a processor 11, a RAM (Random Access Memory) 12, a ROM (Read Only Memory) 13, and a storage apparatus 14. The information processing system 1 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing system 1, through a network interface. The processor 11 controls the RAM 12, the storage apparatus 14, the input apparatus and the output apparatus 16 by executing the read computer program. Especially in this example embodiment, when the processor 11 executes the read computer program, a functional block for performing a classification using a likelihood ratio and a learning process related to the classification is realized or implemented in the processor 11. An example of the processor 11 includes a CPU (Central Processing Unit), a GPU (Graphics Processing Unit), a FPGA (field-programmable gate array), a DSP (Demand-Side Platform), and an ASIC (Application Specific Integrated Circuit). The processor 11 may use one of the examples described above, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the information processing system 1. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 1. The input apparatus 15 may include, for example, at least one of a keyboard, a mouse, and a touch panel. The input apparatus 15 may be a dedicated controller (operation terminal). The input apparatus 15 may also include a terminal owned by the user (e.g., a smartphone or a tablet terminal, etc.). The input apparatus 15 may be an apparatus that allows an audio input including a microphone, for example.

The output apparatus 16 is an apparatus that outputs information about the information processing system 1 to the outside. For example, the output apparatus 16 may be a display apparatus (e.g., a display) that is configured to display the information about the information processing system 1. The display apparatus here may be a TV monitor, a personal computer monitor, a smartphone monitor, a tablet terminal monitor, or another portable terminal monitor. The display apparatus may be a large monitor or a digital signage installed in various facilities such as stores. The output apparatus 16 may be an apparatus that outputs the information in a format other than an image. For example, the output apparatus 16 may be a speaker that audio-outputs the information about the information processing system 1.

### (Functional Configuration)

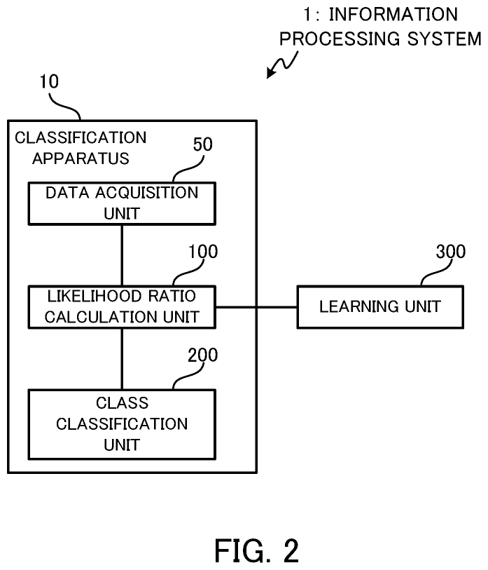

Next, a functional configuration of the information processing system 1 according to the first example embodiment will be described with reference to FIG. 2. FIG. 2 is a block diagram illustrating the functional configuration of the information processing system according to the first example embodiment.

As illustrated in FIG. 2, the information processing system 1 according to the first example embodiment includes a classification apparatus 10 and a learning unit 300. The classification apparatus 10 is an apparatus for performing class classification of inputted series data, and includes, as processing blocks for realizing the functions thereof, a data acquisition unit 50, a likelihood ratio calculation unit 100, and a class classification unit 200. Furthermore, the learning unit 300 is configured to perform a learning process related to the classification apparatus 10. Although the learning unit 300 is provided separately from the classification apparatus 10, the classification apparatus 10 may include the learning unit 300. Each of the data acquisition unit 50, the likelihood ratio calculation unit 100, the class classification unit 200, and the learning unit 300 may be realized or implemented by the processor 11 (see FIG. 1).

The data acquisition unit 50 is configured to obtain a plurality of elements included in the series data. The data acquisition unit 50 may directly obtain data from an arbitrary data acquisition apparatus (e.g., a camera, a microphone, etc.) or may read data obtained in advance by a data acquisition apparatus and stored in a storage or the like. When data are obtained from a camera, the data acquisition unit 50 may be configured to obtain the data from each of a plurality of cameras. The elements of the series data obtained by the data acquisition unit 50 is configured to be outputted to the likelihood ratio calculation unit 100. The series data are data including a plurality of elements arranged in a predetermined order, and an example thereof is time series data, for example. A more specific example of the series data includes, but is not limited to, video data and audio data.

The likelihood ratio calculation unit 100 is configured to calculate a likelihood ratio on the basis of at least two consecutive elements of the plurality of elements obtained by the data acquisition unit 50. The “likelihood ratio” here is an index indicating a likelihood of a class to which the series data belong. The likelihood ratio may be calculated as a log likelihood ratio (LLR), for example. A specific example of the likelihood ratio and a specific calculation method will be described in detail in another example embodiment described later.

The class classification unit 200 is configured to classify the series data on the basis of the likelihood ratio calculated by the likelihood ratio calculation unit 100. The class classification unit 200 selects at least one class to which the series data belong, from among a plurality of classes that are classification candidates. The plurality of classes that are classification candidates may be set in advance. Alternatively, the plurality of classes that are classification candidates may be set by the user as appropriate, or may be set as appropriate on the basis of a type of the series data to be handled.

The learning unit 300 performs learning related to the calculation of the likelihood ratio in the classification apparatus 10. Specifically, the learning unit 300 performs learning of the likelihood ratio calculation unit 100 in the classification apparatus 10, by using training data prepared in advance. In particular, the learning unit 300 according to this example embodiment changes a degree of contribution to the learning (hereinafter referred to as a “learning contribution degree”) of a plurality of series data that are the training data, in accordance with ease of classification of the series data. The learning contribution degree is a degree indicating an extent of an influence of the series data on the learning, and as the learning contribution degree is increased, the influence on the learning is increased. A more specific way of changing the learning contribution degree will be described in detail in another example embodiment described later.

### (Flow of Classification Operation)

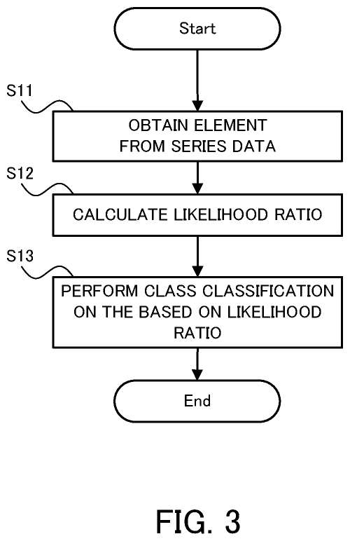

Next, with reference to FIG. 3, a flow of operation of the classification apparatus 10 in the information processing system 1 according to the first example embodiment (specifically, a class classification operation after the learning) will be described. FIG. 3 is a flowchart illustrating the flow of the operation of the classification apparatus in the information processing system according to the first example embodiment.

As illustrated in FIG. 3, when the operation of the classification apparatus 10 is started, first, the data acquisition unit 50 obtains elements included in the series data (step S11). The data acquisition unit 50 outputs the obtained elements of the series data to the likelihood ratio calculation unit 100. Then, the likelihood ratio calculation unit 100 calculates the likelihood ratio on the basis of the obtained two or more elements (step S12).

Subsequently, the class classification unit 200 performs the class classification on the basis of the calculated likelihood ratio (step S13). The class classification may determine a single class to which the series data belong, or may determine a plurality of classes to which the series data are likely to belong. The class classification unit 200 may output a result of the class classification to a display or the like. The class classification unit 200 may output the result of the class classification by audio through a speaker or the like.

### (Flow of Learning Operation)

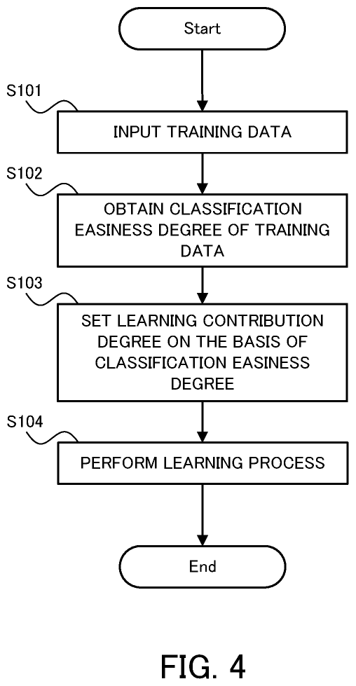

Next, a flow of operation of the learning unit 300 in the information processing system 1 according to the first example embodiment (i.e., a learning operation related to the calculation of the likelihood ratio) will be described with reference to FIG. 4. FIG. 4 is a flowchart illustrating the flow of the operation of the learning unit in the information processing system according to the first example embodiment.

As illustrated in FIG. 4, when the learning operation is started, first, the training data are inputted to the learning unit 300 (step S101). The training data may be configured as a set of the series data and information about a correct answer class to which the series data belong (i.e., correct answer data), for example.

Subsequently, the training unit 300 obtains information about a classification easiness degree of the series data inputted as the training data (step S102). The “classification easiness degree” here is a value indicating a degree of ease of classification of the series data, and more specifically, it is a value indicating the ease of classification of the series data into the correct answer class by the class classification unit 200 in the classification apparatus 10. The classification easiness degree can be determined, for example, by inputting the training data to the classification apparatus 10 and actually performing a classification process. A specific method of determining the classification easiness degree of the series data will be described in detail in another example embodiment described later. The learning unit 300 may read and obtain the classification easiness degree that is obtained in advance when learning it. That is, the classification easiness degree may be obtained only by reading without performing the process of classifying the training data in the learning.

Subsequently, the learning unit 300 sets the learning contribution degree of the series data on the basis of the obtained classification easiness degree (step S103). The learning unit 300 is allowed to set the learning contribution degree by weighting a loss function calculated from the series data, for example. For example, while the learning contribution degree of the series data with the weight increased becomes higher, the learning contribution degree of the series data with the weight reduced becomes lower. The setting of the learning contribution degree using the weight is an example, and the learning contribution degree may be set by using another technique. Subsequently, the learning unit 300 performs the learning process in view of the learning contribution degree (step S104). In this case, if the learning contribution of the series data used for the learning is set high, an influence thereof on the learning process is relatively large. On the other hand, if the learning contribution degree of the series data used for the learning is set low, the influence thereof on the learning process is relatively small. A specific aspect of the learning process is not particularly limited, but a method of optimizing a parameter using a loss function may be used, for example. For example, the method of optimizing the parameter may use an error back propagation method, or may use another technique.

### (Technical Effect)

Next, a technical effect obtained by the information processing system 1 according to the first example embodiment will be described.

As described in FIG. 1 to FIG. 4, in the information processing system 1 according to the first example embodiment, the learning contribution degree is set in accordance with the classification easiness degree of the series data that are the training data. Therefore, it is possible to change the influence on the learning between the series data that are easy to classify and the series data that are hard to classify. If such learning is performed, it is possible to perform more effective learning than that when all the series data have a uniform learning contribution degree. That is, if the learning contribution degree is set in accordance with the classification easiness degree, it is possible to adjust the influence of each series data on the learning to an appropriate one, and to perform the learning more efficiently. Consequently, the class classification by the classification apparatus 10 may be performed with higher accuracy.

### Second Example Embodiment

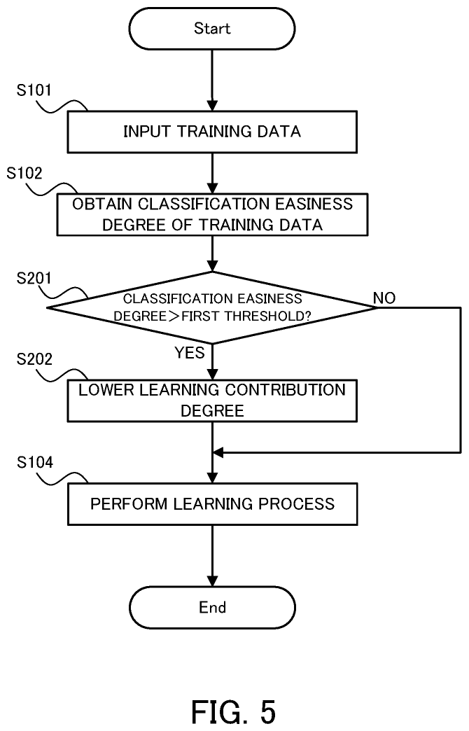

The information processing system 1 according to a second example embodiment will be described with reference to FIG. 5 to FIG. 7. The second example embodiment is partially different from the first example embodiment only in the operation, and may be the same as the first example embodiment in the apparatus configuration (see FIG. 1 and FIG. 2), the operation of the classification apparatus 10 (see FIG. 3) or the like, for example. For this reason, a part that is different from the first example embodiment will be described in detail below, and a description of other overlapping parts will be omitted as appropriate.

### (Flow of Learning Operation)

First, a flow of operation of the learning unit 300 in the information processing system 1 according to the second example embodiment will be described with reference to FIG. 5. FIG. 5 is a flowchart illustrating the flow of the operation of the learning unit in the information processing system according to the second example embodiment. In FIG. 5, the same steps as those illustrated in FIG. 4 carry the same reference numerals.

As illustrated in FIG. 5, when the learning operation in the information processing system 1 according to the second example embodiment is started, first, the training data are inputted to the learning unit 300 (step S101). Then, the learning unit 300 obtains information about the classification easiness degree of the series data inputted as the training data (step S102).

Subsequently, especially in the second example embodiment, the learning unit 300 determines whether or not the obtained classification easiness degree is higher than a first threshold (step S201). The “first threshold” here is a threshold for determining whether or not the classification easiness degree is sufficiently high (in other words, whether or not the series data are easy to classify). The first threshold may be determined by prior simulation or the like, for example.

When the classification easiness degree is higher than the first threshold (step S201: YES), the learning unit 300 lowers the learning contribution degree of the series data (step S202). For example, the learning unit 300 changes the learning contribution degree to be lower than an initial value, for the series data in which the classification easiness degree is higher than the first threshold. On the other hand, when the classification easiness degree is not higher than the first threshold (step S201: NO), the learning unit 300 does not perform the step S202 on the series data (i.e., does not lower the learning contribution degree). For example, the learning unit 300 maintains the learning contribution degree at the initial value, for the series data in which the classification easiness degree is not higher than the first threshold. In this way, while the learning contribution degree of the series data in which the classification easiness degree is higher than the first threshold (in other words, the series data that are easy to classify) becomes relatively low, the learning contribution degree of the series data in which the classification easiness degree is not higher than the first threshold (in other words, the series data that are hard to classify) becomes relatively high.

Then, the learning unit 300 performs the learning process in view of the learning contribution degree (step S104). Specifically, when the learning contribution degree is lowered in the step S202, the influence on the learning using the series data is relatively small. On the other hand, when the step S202 is not performed (i.e., the learning contribution degree is not lowered), the influence on the learning using the series data is relatively large.

### First Modified Example

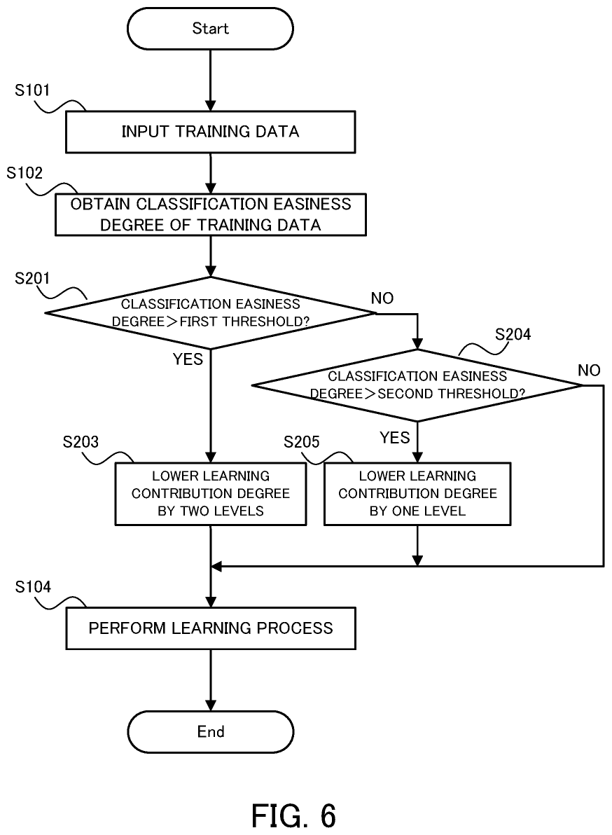

Next, a flow of operation in a first modified example of the learning unit 300 in the information processing system 1 according to the second example embodiment will be described with reference to FIG. 6. FIG. 6 is a flowchart illustrating the flow of the operation in the first modified example of the learning unit in the information processing system according to the second example embodiment. In FIG. 6, the same steps as those illustrated in FIG. 5 carry the same reference numerals.

As illustrated in FIG. 6, when the learning operation according to the first modified example is started, first, the training data are inputted to the learning unit 300 (step S101). Then, the learning unit 300 obtains information about the classification easiness degree of the series data inputted as the training data (step S102).

Subsequently, the learning unit 300 determines whether or not the obtained classification easiness degree is higher than the first threshold (step S201). Especially in the first modified example, when the classification easiness degree is higher than the first threshold (step S201: YES), the learning contribution degree of the series data is lowered by two levels (step S203). That is, the learning unit 300 significantly lowers the learning contribution degree of the series data in which it is determined that the classification easiness degree is higher than the first threshold.

On the other hand, when the classification easiness degree is not high than the first threshold (step S201: NO), the learning unit 300 determines whether the obtained classification easiness degree is higher than a second threshold (step S204). The “second threshold” here is a threshold for determining whether the classification easiness degree is rather high or low from among the series data in which it is determined that the classification easiness degree is lower than the first threshold. Therefore, the second threshold is set to be lower than the first threshold. The second threshold may be determined by prior simulation or the like, for example.

When the classification easiness degree is higher than the second threshold (step S204: YES), the learning unit 300 lowers the learning contribution degree of the series data by one level (step S205). That is, the learning unit 300 slightly lowers the learning contribution degree of the series data in which the classification easiness degree is higher than the second threshold, in comparison with the step S203. On the other hand, when the classification easiness degree is not higher than the second threshold (step S204: NO), the learning unit 300 does not perform the step S205 on the series data (i.e., does not lower the learning contribution degree).

According to the process to this point, the learning contribution degree is set in three patterns in accordance with the classification easiness degree, that is, “lowered by two levels”, “lowered by one level”, and “not lowered”.

Then, the learning unit 300 performs the learning process in view of the learning contribution degree (step S104). Specifically, when the learning contribution degree is lowered by two levels in the step S203, the influence on the learning using the series data is significantly reduced. In addition, when the learning contribution degree is lowered by one level in the step S205, the influence on the learning using the series data is slightly reduced. On the other hand, when neither the step S203 nor the step S205 is performed (i.e., when the learning contribution degree is not reduced), the influence on the learning using the series data is greater than that when the learning contribution degree is lowered.

### Second Modified Example

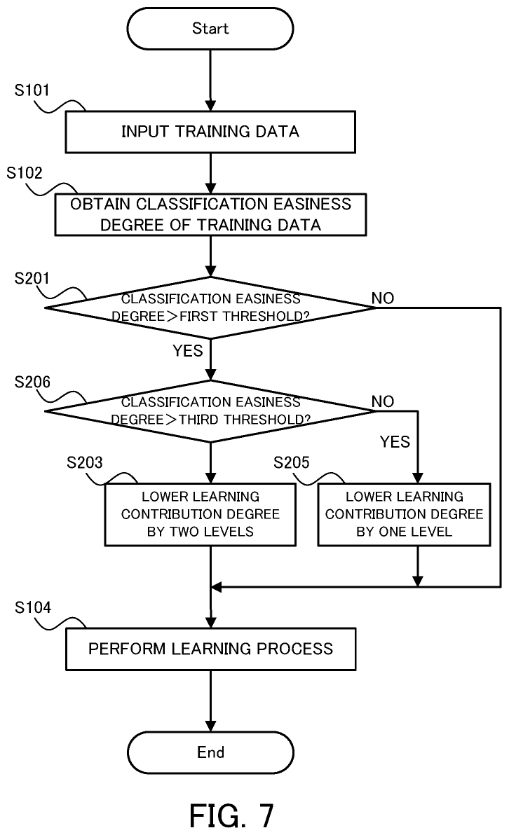

Next, a flow of operation in a second modified example of the learning unit 300 in the information processing system 1 according to the second example embodiment will be described with reference to FIG. 7. FIG. 7 is a flowchart illustrating the flow of the operation in the second modified example of the learning unit in the information processing system according to the second example embodiment. In FIG. 7, the same steps as those illustrated in FIG. 5 and FIG. 6 carry the same reference numerals.

As illustrated in FIG. 7, when the learning operation according to the second modified example is started, first, the training data are inputted to the learning unit 300 (step S101). Then, the learning unit 300 obtains information about the classification easiness degree of the series data inputted as the training data (step S102).

Subsequently, the learning unit 300 determines whether or not the obtained classification easiness degree is higher than the first threshold (step S201). Especially in the second modified example, when the classification easiness degree is higher than the first threshold (step S201: YES), the learning unit 300 determines whether or not the obtained classification easiness degree is higher than a third threshold (step S206). The “third threshold” here is a threshold for determining whether the classification easiness degree is rather high or low from among the series data in which it is determined that the classification easiness degree is higher than the first threshold. Therefore, the third threshold is set to be higher than the first threshold. The third threshold may be determined by prior simulation or the like, for example.

When the classification easiness degree is higher than the third threshold (step S206: YES), the learning unit 300 lowers the learning contribution degree of the series data by two levels (step S203). That is, the learning unit 300 significantly lowers the learning contribution degree of the series data in which it is determined that the classification easiness degree is higher than the third threshold. On the other hand, when the classification easiness degree is not higher than the third threshold (step S206: NO), the learning unit 300 lowers the learning contribution degree of the series data by one level (step S205). That is, the learning unit 300 slightly lowers the learning contribution degree of the series data in which it is determined that the classification easiness degree is higher than the first threshold but is lower than the third threshold. On the other hand, when the classification easiness degree is not higher than the first threshold (step S201: NO), the learning unit 300 does not perform any of the steps S203 and S205 on the series data (i.e., does not lower the learning contribution degree).

According to the process to this point, as in the first modified example, the learning contribution degree is set in three patterns in accordance with the classification easiness degree, that is, “lowered by two levels”, “lowered by one level”, and “not lowered”.

Then, the learning unit 300 performs the learning process in view of the learning contribution degree (step S104). Specifically, when the learning contribution degree is lowered by two levels in the step S203, the influence on the learning using the series data is significantly reduced. In addition, when the learning contribution degree is lowered by one level in the step S205, the influence on the learning using the series data is slightly reduced. On the other hand, when neither the step S203 nor the step S205 is performed (i.e., when the learning contribution degree is not reduced), the influence on the learning using the series data is greater than that when the learning contribution degree is lowered.

In the first modified example and the second modified example, it is exemplified that the learning contribution degree is lowered by one level or two levels, but the learning contribution degree may be lowered by more levels. For example, the learning contribution degree may be lowered by three levels, or the learning contribution degree may be lowered by four or more levels.

The learning contribution degree may be changed, not stepwise in accordance with the threshold, but linearly. In this case, a relational expression indicating a relationship between the classification easiness degree and an extent of lowering the learning contribution degree may be prepared, and the learning contribution degree may be lowered by using the relational expression. Furthermore, a table indicating the relationship between the classification easiness degree and the extent of lowering the learning contribution degree may be prepared, and the learning contribution degree may be lowered by using the table.

### (Technical Effect)

Next, a technical effect obtained by the information processing system 1 according to the second example embodiment will be described.

As described in FIG. 5 to FIG. 7, in the information processing system 1 according to the second example embodiment, the learning contribution degree of the series data with a high classification easiness degree (i.e., that are easy to classify) is lowered. In this way, it is possible to relatively reduce the influence on the learning of the series data that are easy to classify and to relatively increase the influence on the learning of the series data that are hard to classify. Then, the learning is performed intensively on the series data that are hard to classify (e.g., data around a classification boundary). As a result, it is possible to classify even the data that are hard to classify, with high accuracy.

### Third Example Embodiment

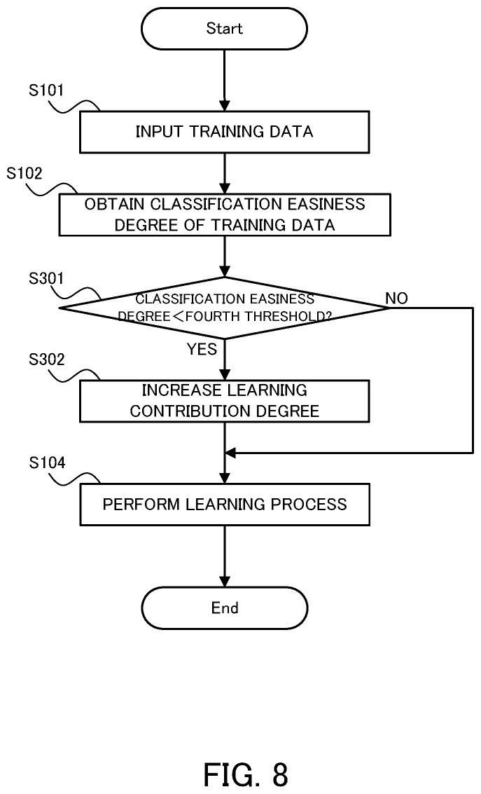

The information processing system 1 according to a third example embodiment will be described with reference to FIG. 8 to FIG. 10. The third example embodiment is partially different from the first and second example embodiments only in the operation, and may be the same as the first and second example embodiments in the other parts. For this reason, a part that is different from each of the example embodiments described above will be described in detail below, and a description of other overlapping parts will be omitted as appropriate.

### (Flow of Learning Operation)

First, a flow of operation of the learning unit 300 in the information processing system 1 according to the third example embodiment will be described with reference to FIG. 8. FIG. 8 is a flowchart illustrating the flow of the operation of the learning unit in the information processing system according to the third example embodiment. In FIG. 8, the same steps as those illustrated in FIG. 4 carry the same reference numerals.

As illustrated in FIG. 8, when the learning operation in the information processing system 1 according to the third example embodiment is started, first, the training data are inputted to the learning unit 300 (step S101). Then, the learning unit 300 obtains information about the classification easiness degree of the series data inputted as the training data (step S102).

Subsequently, especially in the third example embodiment, the learning unit 300 determines whether or not the obtained classification easiness degree is lower than a fourth threshold (step S301). The “fourth threshold” here is a threshold for determining whether or not the classification easiness degree is sufficiently low (in other words, whether or not the series data are hard to classify). The fourth threshold may be determined by prior simulation or the like, for example.

When the classification easiness degree is lower than the fourth threshold (step S301: YES), the learning unit 300 increases the learning contribution degree of the series data (step S302). For example, the learning unit 300 changes the learning contribution degree to be higher than the initial value, for the series data in which the classification easiness degree is lower than the fourth threshold. On the other hand, when the classification easiness degree is not lower than the fourth threshold (step S301: NO), the learning unit 300 does not perform the step S302 for the series data (i.e., does not increase the learning contribution degree). For example, the learning unit 300 maintains the learning contribution degree at the initial value, for the series data in which the classification easiness degree is not higher than the fourth threshold. In this way, while the learning contribution degree of the series data in which the classification easiness degree is lower than the fourth threshold (in other words, the series data that are hard to classify) becomes relatively high, the learning contribution degree of the series data in which the classification easiness degree is not lower than the fourth threshold (in other words, the series data that are easy to classify) becomes relatively low.

Then, the learning unit 300 performs the learning process in view of the learning contribution degree (step S104). Specifically, when the learning contribution degree is increased in the step S302, the influence on the learning using the series data is relatively large. On the other hand, when the step S302 is not performed (i.e., when the learning contribution degree is not increased), the influence on the learning using the series data is relatively small.

### First Modified Example

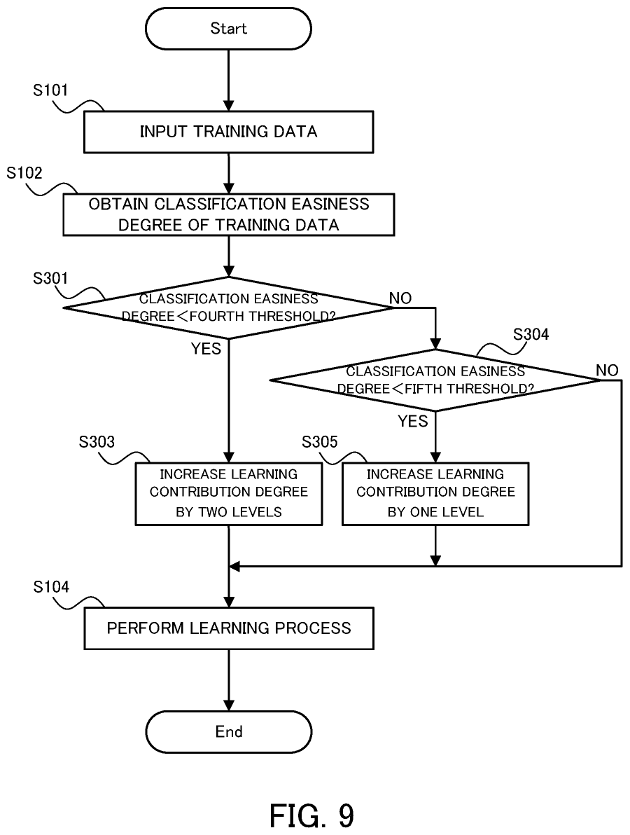

Next, a flow of operation in a first modified example of the learning unit 300 in the information processing system 1 according to the third example embodiment will be described with reference to FIG. 9. FIG. 9 is a flowchart illustrating the flow of the operation in the first modified example of the learning unit in the information processing system according to the third example embodiment. In FIG. 9, the same steps as those illustrated in FIG. 8 carry the same reference numerals.

As illustrated in FIG. 8, when the learning operation according to the first modified example is started, first, the training data are inputted to the learning unit 300 (step S101). Then, the learning unit 300 obtains information about the classification easiness degree of the series data inputted as the training data (step S102).

Subsequently, the learning unit 300 determines whether or not the obtained classification easiness degree is lower than the fourth threshold (step S301). Especially in the first modified example, when the classification easiness degree is lower than the fourth threshold (step S301: YES), the learning unit 300 increases the learning contribution degree of the series data by two levels (step S303). That is, the learning unit 300 significantly increases the learning contribution degree of the series data in which it is determined that the classification easiness degree is lower than the fourth threshold.

On the other hand, when the classification easiness degree is not lower than the fourth threshold (step S301: NO), the learning unit 300 determines whether the obtained classification easiness degree is lower than a fifth threshold (step S304). The “fifth threshold” here is a threshold for determining whether the classification easiness degree is rather high or low from among the series data in which it is determined that the classification easiness degree is higher than the fourth threshold. Therefore, the fifth threshold is set to be higher than the fourth threshold. The fifth threshold may be determined by prior simulation or the like, for example.

When the classification easiness degree is lower than the fifth threshold (step S304: YES), the learning unit 300 increases the learning contribution degree of the series data by one level (step S305). That is, the learning unit 300 slightly lowers the learning contribution degree of the series data in which the classification easiness degree is lower than the fifth threshold, in comparison with the step S303. On the other hand, when the classification easiness degree is not lower than the fifth threshold (step S304: NO), the learning unit 300 does not perform the step S305 on the series data (i.e., does not lower the learning contribution degree).

According to the process to this point, the learning contribution degree is set in three patterns in accordance with the classification easiness degree, that is, “increased by two levels”, “increased by one level”, and “not increased”.

Then, the learning unit 300 performs the learning process in view of the learning contribution degree (step S104). Specifically, when the learning contribution degree is increased by two levels in the S303, the influence on the learning using the series data is significantly increased. In addition, when the learning contribution degree is increased by one level in the step S305, the influence on the learning using the series data is slightly increased. On the other hand, when neither the step S303 nor the step S305 is performed (i.e., the learning contribution degree is not increased), the influence on the learning using the series data is smaller than that when the learning contribution degree is increased.

### Second Modified Example

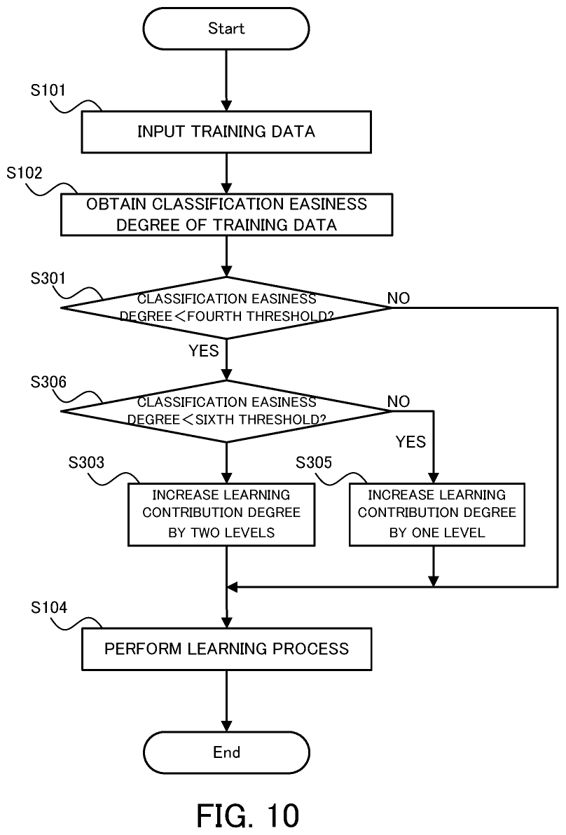

Next, a flow of operation in a second modified example of the learning unit 300 in the information processing system 1 according to the third example embodiment will be described with reference to FIG. 10. FIG. 10 is a flowchart illustrating the flow of the operation in the second modified example of the learning unit in the information processing system according to the third example embodiment. In FIG. 10, the same steps as those illustrated in FIG. 8 and FIG. 9 carry the same reference numerals.

As illustrated in FIG. 10, when the learning operation according to the second modified example is started, first, the training data are inputted to the learning unit 300 (step S101). Then, the learning unit 300 obtains information about the classification easiness degree of the series data inputted as the training data (step S102).

Subsequently, the learning unit 300 determines whether or not the obtained classification easiness degree is lower than the fourth threshold (step S301). Especially in the second modified example, when the classification easiness degree is lower than the fourth threshold (step S301: YES), the learning unit 300 determines whether or not the obtained classification easiness degree is lower than a sixth threshold (step S306). The “sixth threshold” here is a threshold for determining whether the classification easiness degree is rather high or low from among the series data in which it is determined that the classification easiness degree is lower than the fourth threshold. Therefore, the sixth threshold is set to be lower than the fourth threshold. The sixth threshold may be determined by prior simulation or the like, for example.

When the classification easiness degree is lower than the sixth threshold (step S306: YES), the learning unit 300 increases the learning contribution degree of the series data by two levels (step S303). That is, the learning unit 300 significantly increases the learning contribution degree of the series data in which it is determined that the classification easiness degree is lower than the sixth threshold. On the other hand, when the classification easiness degree is not lower than the sixth threshold (step S306: NO), the learning unit 300 increases the learning contribution degree of the series data by one level (step S305). That is, the learning unit 300 slightly increases the learning contribution degree of the series data in which it is determined that the classification easiness degree is lower than the fourth threshold but is higher than the sixth threshold. On the other hand, when the classification easiness degree is not lower than the fourth threshold (step S301: NO), the learning unit 300 does not perform any of the steps S303 and S305 on the series data (i.e., does not increase the learning contribution degree).

According to the process to this point, as in the first modified example, the learning contribution degree is set in three patterns in accordance with the classification easiness degree, that is, “increased by two levels”, “increased by one level”, and “not increased”.

Then, the learning unit 300 performs the learning process in view of the learning contribution degree (step S104). Specifically, when the learning contribution degree is increased by two levels in the S303, the influence on the learning using the series data is significantly increased. In addition, when the learning contribution degree is increased by one level in the step S305, the influence on the learning using the series data is slightly increased. On the other hand, when neither the step S303 nor the step S305 is performed (i.e., the learning contribution degree is not increased), the influence on the learning using the series data is smaller than that when the learning contribution degree is increased.

In the first modified example and the second modified example, it is exemplified that the learning contribution degree is increased by one level or two levels, but the learning contribution degree may be increased by more levels. For example, the learning contribution degree may be increased by three levels, or the learning contribution degree may be increased by four or more levels.

The learning contribution degree may be changed, not stepwise in accordance with the threshold, but linearly. In this case, a relational expression indicating a relationship between the classification easiness degree and an extent of lowering the learning contribution degree may be prepared, and the learning contribution degree may be increased by using the relational expression. Furthermore, a table indicating the relationship between the classification easiness degree and the extent of lowering the learning contribution degree may be prepared, and the learning contribution degree may be increased by using the table.

### (Technical Effect)

Next, a technical effect obtained by the information processing system 1 according to the third example embodiment will be described.

As described in FIG. 8 to FIG. 10, in the information processing system 1 according to the third example embodiment, the learning contribution degree of the series data with a low classification easiness degree (i.e., that are hard to classify) is increased. In this way, it is possible to relatively reduce the influence on the learning of the series data that are easy to classify and to relatively increase the influence on the learning of the series data that are hard to classify. Then, the learning is performed intensively on the series data that are hard to classify (e.g., data around the classification boundary). As a result, it is possible to classify even the data that are hard to classify, with high accuracy.

### Combination of Second and Third Example Embodiments

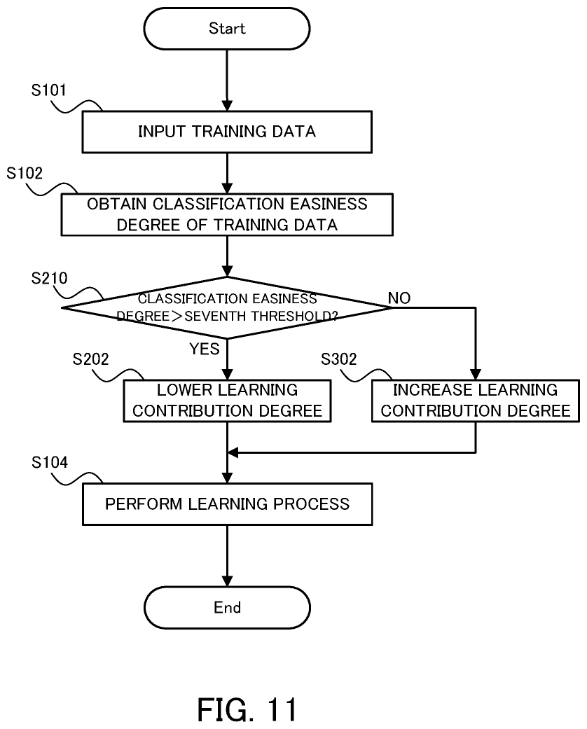

Next, an example of combining the second example embodiment and the third example embodiment described above will be described with reference to FIG. 11. FIG. 11 is a flowchart illustrating a flow of operation of the learning unit when the information processing systems according to the second example embodiment and the third example embodiment are combined. In FIG. 11, the same steps as those illustrated in FIG. 5 and FIG. 8 carry the same reference numerals.

In the learning operation illustrated in FIG. 11, first, the training data are inputted to the learning unit 300 (step S101). Then, the learning unit 300 obtains information about the classification easiness degree of the series data inputted as the training data (step S102).

Subsequently, the training unit 300 determines whether or not the obtained classification easiness degree is higher than a seventh threshold (step S210). The “seventh threshold” here is a threshold for determining whether the classification easiness degree is high or low (in other words, whether the series data are easy to classify or hardly classified). The seventh threshold may be determined by prior simulation or the like, for example. The seventh threshold may be the same value as the first threshold in the second example embodiment. The step S210 may be a step for determining whether or not the obtained classification easiness degree is lower than the seventh threshold (in this case, “YES” and “NO” in the flowchart may be reversed). The seventh threshold at this time may have the same value as that of the fourth threshold in the third example embodiment.

When the classification easiness degree is higher than the seventh threshold (step S207: YES), the learning unit 300 lowers the learning contribution degree of the series data (step S202). For example, the learning unit 300 changes the learning contribution degree to be lower than the initial value, for the series data in which the classification easiness degree is higher than the seventh threshold. On the other hand, when the classification easiness degree is not higher than the seventh threshold (step S210: NO), the learning unit 300 increases the learning contribution degree of the series data (step S302). For example, the learning unit 300 changes the learning contribution degree to be higher than the initial value, for the series data in which the classification easiness degree is lower than the seventh threshold.

Then, the learning unit 300 performs the learning process in view of the learning contribution degree (step S104). In this way, the influence on the learning is relatively small, for the series data in which the learning contribution degree is reduced in the step S202. On the other hand, the influence on the learning is relatively large, for the series data in which the learning contribution degree is increased in the step S302. As described above, even when the process of reducing the learning contribution degree is combined with the process of increasing the learning contribution degree, it is possible to properly set the learning contribution degree in accordance with the classification easiness degree.

### Fourth Example Embodiment

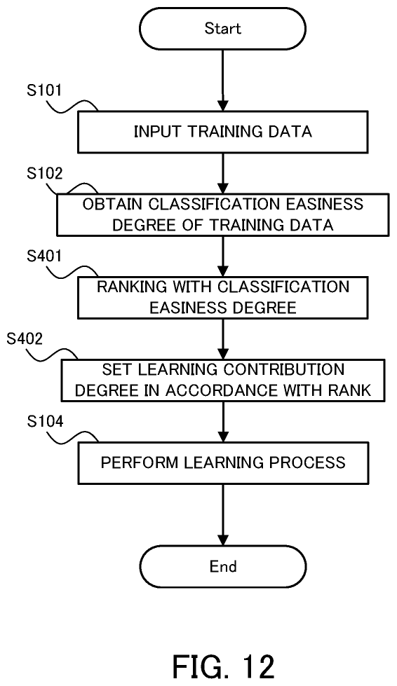

The information processing system 1 according to a fourth example embodiment will be described with reference to FIG. 12 to FIG. 15. The fourth example embodiment is partially different from the first to third example embodiments only in the operation, and may be the same as the first to third example embodiments in the other parts. For this reason, a part that is different from each of the example embodiments described above will be described in detail below, and a description of other overlapping parts will be omitted as appropriate.

### (Flow of Learning Operation)

First, a flow of operation of the learning unit 300 in the information processing system 1 according to the fourth example embodiment will be described with reference to FIG. 12. FIG. 12 is a flowchart illustrating the flow of the operation of the learning unit in the information processing system according to the fourth example embodiment. In FIG. 12, the same steps as those illustrated in FIG. 4 carry the same reference numerals.

As illustrated in FIG. 12, when the learning operation in the information processing system 1 according to the fourth example embodiment is started, first, the training data are inputted to the learning unit 300 (step S101). Then, the learning unit 300 obtains information about the classification easiness degree of the series data inputted as the training data (step S102).

Subsequently, especially in the fourth example embodiment, the learning unit 300 ranks the series data on the basis of the classification easiness degree (step S401). The learning unit 300 ranks a plurality of series data in descending order of the classification easiness degree (in other words, in order of ease of classification), for example. Alternatively, the learning unit 300 may rank the plurality of series data in ascending order of the classification easiness degree (in other words, in order of difficulty of the classification).

Subsequently, the learning unit 300 sets the learning contribution degree in accordance with a rank (step S402). When ranking the series data in descending order of the classification easiness degree, the learning unit 300 may set the learning contribution degree to be lower as the rank is higher (i.e., as the series data are easier to classify). Alternatively, when ranking the series data in ascending order of the classification easiness degree, the learning unit 300 may set the learning contribution degree to be higher as the rank is higher (i.e., as the series data are hard to classify).

Then, the learning unit 300 performs the learning process in view of the learning contribution degree (step S104). Here, as the learning contribution degree is set to be lower, the influence on the learning using the series data is smaller. On the other hand, as the learning contribution degree is set to be higher, the influence on the learning using the series data is increased.

### (Example of Setting Learning Contribution Degree)

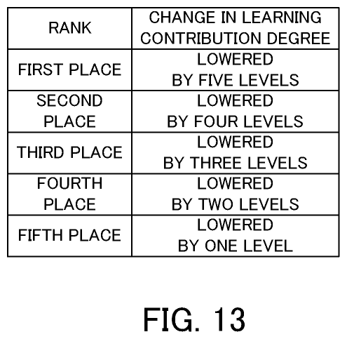

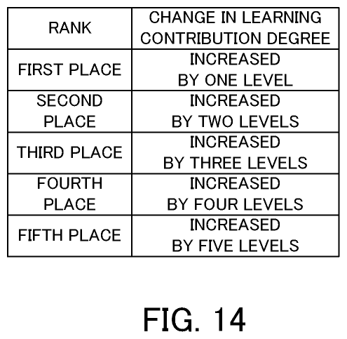

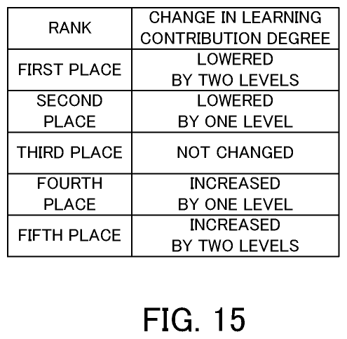

Next, specific examples of setting the learning contribution degree based on the ranking will be described with reference to FIG. 13 to FIG. 15. FIG. 13 is version 1 of a table illustrating an example of setting the learning contribution degree by the learning unit in the information processing system according to the fourth example embodiment. FIG. 14 is version 2 of a table illustrating an example of setting the learning contribution degree by the learning unit in the information processing system according to the fourth example embodiment. FIG. 15 is version 3 of a table illustrating an example of setting the learning contribution degree by the learning unit in the information processing system according to the fourth example embodiment. In the examples illustrated in FIG. 13 to FIG. 15, it is assumed that the rank is higher as the classification easiness degree is higher (i.e., as the series data are easier to classify).

As illustrated in FIG. 13, in the information processing system 1 according to the fourth example embodiment, as the rank is higher (i.e., as the series data are easier to classify), the extent of lowering the learning contribution degree may be increased. In the example illustrated in FIG. 13, for the series data that are ranked in the first place, the learning contribution degree is lowered by five levels. For the series data that are ranked in the second place, the learning contribution degree is lowered by four levels. For the series data that are ranked in the third place, the learning contribution degree is lowered by three levels. For the series data that are ranked in the fourth place, the learning contribution degree is lowered by two levels. For the series data that are ranked in the fifth place, the learning contribution degree is lowered by one level. In this way, as the classified series data are easier to classify, the learning contribution degree can be set to be lower.

As illustrated in FIG. 14, in the information processing system 1 according to the fourth example embodiment, as the rank is higher (i.e., as the series data are easier to classify), the extent of increasing the learning contribution may be reduced. In the example illustrated in FIG. 14, for the series data that are ranked in the first place, the learning contribution degree is increased by one level. For the series data that are ranked in the second place, the learning contribution degree is increased by two levels. For the series data that are ranked in the third place, the learning contribution degree is increased by three levels. For the series data that are ranked in the fourth place, the learning contribution degree is increased by four levels. For the series data that are ranked in the fifth place, the learning contribution degree is increased by five levels. Even in this case, as the classified series data are easier to classify, the learning contribution degree can be set to be lower.

As illustrated in FIG. 15, in the information processing system 1 according to the fourth example embodiment, the learning contribution degree may be increased or lowered in accordance with the rank. In the example illustrated in FIG. 15, for the series data that are ranked in the first place, the learning contribution degree is lowered by two levels. For the series data that are ranked in the second place, the learning contribution degree is lowered by one level. For the series data that are ranked in the third place, the learning contribution degree is not changed (i.e., is maintained as the initial value). For the series data that are ranked in the fourth place, the learning contribution degree is increased by one level. For the series data that are ranked in the fifth place, the learning contribution degree is increased by two levels. Even in this case, as the classified series data are easier to classify, the learning contribution degree can be set to be lower.

The setting examples illustrated in FIG. 13 to FIG. 15 are merely examples, and the learning contribution degree may be set in another technique. That is, as long as the learning contribution degree is determined in accordance with the rank of ease of classification, a specific content of the technique is not limited.

### (Technical Effect)

Next, a technical effect obtained by the information processing system 1 according to the fourth example embodiment will be described.

As described in FIG. 12 to FIG. 15, in the information processing system 1 according to the fourth example embodiment, the learning contribution degree is set on the basis of the rank corresponding to the classification easiness degree. In this way, it is possible to set a proper learning contribution degree in accordance with the ease of classification. For example, it is possible to relatively reduce the influence on the learning of the series data that are easy to classify, or to relatively increase the influence on the learning of the series data that are hard to classify. As a result, the learning makes it possible to classify even the data that are hard to classify, with high accuracy.

### Fifth Example Embodiment

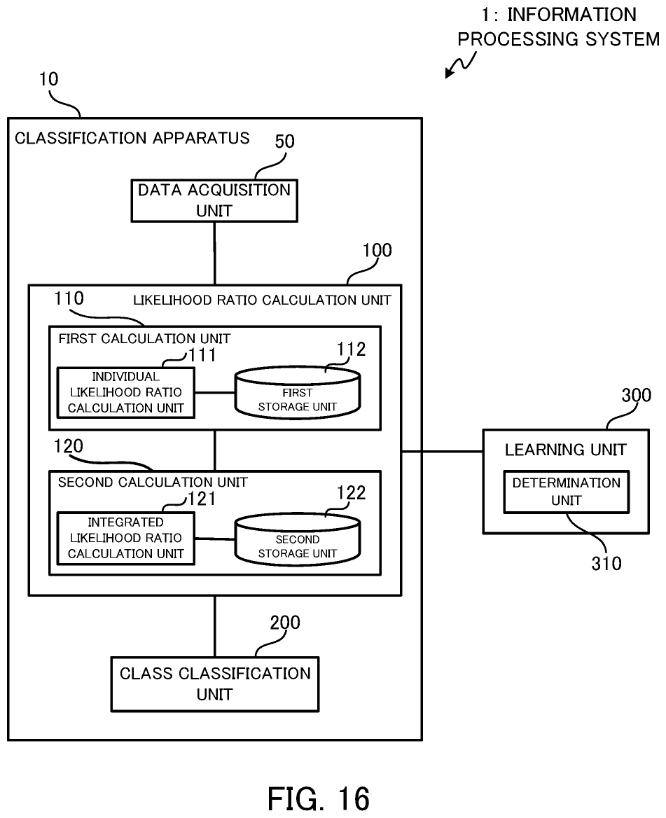

The information processing system 1 according to a fifth example embodiment will be described with reference to FIG. 16 to FIG. 19. The fifth example embodiment is partially different from the first to fourth example embodiments only in the configuration and operation, and may be the same as the first to fourth example embodiments in the other parts. For this reason, a part that is different from each of the example embodiments described above will be described in detail below, and a description of other overlapping parts will be omitted as appropriate.

### <Functional Configuration>

First, a functional configuration of the information processing system 1 according to the fifth example embodiment will be described with reference to FIG. 16. FIG. 16 is a block diagram illustrating the functional configuration of the information processing system according to the fifth example embodiment. In FIG. 16, the same components as those illustrated in FIG. 2 carry the same reference numerals.

As illustrated in FIG. 16, in the information processing system 1 according to the fifth example embodiment, the likelihood ratio calculation unit 100 of the classification apparatus 10 includes a first calculation unit 110 and a second calculation unit 120. The first calculation unit 110 includes an individual likelihood ratio calculation unit 111 and a first storage unit 112. The second calculation unit 120 includes an integrated likelihood ratio calculation unit 121 and a second storage unit 122. Each of the individual likelihood ratio calculation unit 111 and the integrated likelihood ratio calculation unit 121 may be realized or implemented by the processor 11 (see FIG. 1), for example. Each of the first storage unit 112 and the second storage unit 122 may be realized or implemented by the storage apparatus 14 (see FIG. 1), for example.

The first calculation unit 110 is configured to calculate an individual likelihood ratio by using the individual likelihood ratio calculation unit 111 and the first storage unit 112. The individual likelihood ratio calculation unit 111 is configured to calculate the individual likelihood ratio on the basis of two consecutive elements of the elements sequentially obtained by the data acquisition unit 50. More specifically, the individual likelihood ratio calculation unit 111 calculates the individual likelihood ratio on the basis of a newly obtained element and past data stored in the first storage unit 112. Information stored in the first storage unit 112 is configured to be read by the individual likelihood ratio calculation unit 111. When the first storage unit 112 stores the individual likelihood ratio of the past, the individual likelihood ratio calculation unit 111 reads the stored past individual likelihood ratio and calculates a new individual likelihood ratio in view of the obtained element. On the other hand, when the first storage unit 112 stores the element itself obtained in the past, the individual likelihood ratio calculation unit 111 may calculate the past individual likelihood ratio from the stored past element, and may calculate the likelihood ratio for the newly obtained element.

The second calculation unit 120 is configured to calculate an integrated likelihood ratio by using the integrated likelihood ratio calculation unit 121 and the second storage unit 122. The integrated likelihood ratio calculation unit 121 is configured to calculate the integrated likelihood ratio on the basis of a plurality of individual likelihood ratios calculated by the first calculation unit 110. That is, the integrated likelihood ratio is a likelihood ratio calculated on the basis of a plurality of elements considered in the calculation of a plurality of individual likelihood ratios. The integrated likelihood ratio calculation unit 121 calculates a new integrated likelihood ratio by using the individual likelihood ratio calculated by the individual likelihood ratio calculation unit 111 and the integrated likelihood ratio of the past stored in the second storage unit 122. Information stored in the second storage unit 122 (i.e., the past integrated likelihood ratio) is configured to be read by the integrated likelihood ratio calculation unit 121. The integrated likelihood ratio calculated by the second calculation unit 120 is configured to be outputted to the class classification unit 200. The class classification unit 200 performs a class classification of the series data on the basis of the integrated likelihood ratio.

In the information processing system 1 according to the fifth example embodiment, the learning unit 300 further includes a determination unit 310.

The determination unit 310 is configured to determine the classification easiness degree of the series data that are the training data used for the learning. The determination unit 310 determines the classification easiness degree on the basis of the likelihood ratio calculated by the likelihood ratio calculation unit 100. A specific method of determining the classification easiness degree will be described in detail later.

The learning unit 300 according to the fifth example embodiment may perform the learning for the entire likelihood ratio calculation unit 100 (i.e., for the first calculation unit 110 and the second calculation unit 120 together), or may perform the learning separately for the first calculation unit 110 and the second calculation unit 120. Alternatively, the learning unit 300 may be separately provided as a first learning unit that performs the learning only the first calculation unit 110 and a second learning unit that performs the learning only for the second calculation unit 120. In this case, only one of the first learning unit and the second learning unit may be provided.

### <Flow of Likelihood Ratio Calculation Operation>

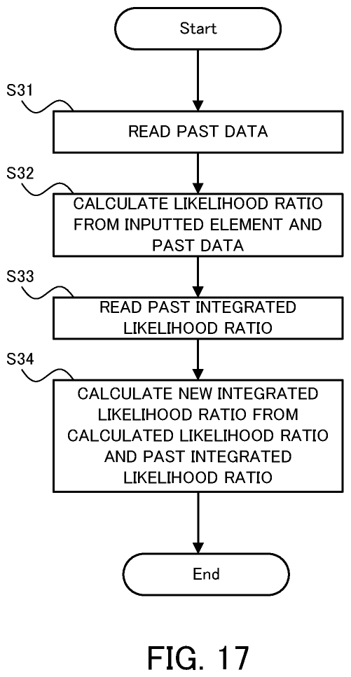

Next, a flow of a likelihood ratio calculation operation (i.e., operation of the likelihood ratio calculation unit 100) in the information processing system 1 according to the fifth example embodiment will be described with reference to FIG. 17. FIG. 17 is a flowchart illustrating the flow of the operation of the likelihood ratio calculation unit in the information processing system according to the fifth example embodiment.

As illustrated in FIG. 17, when the likelihood ratio calculation operation by the likelihood ratio calculation unit 100 according to the fifth example embodiment is started, first, the individual likelihood ratio calculation unit 111 of the first calculation unit 110 reads the past data from the first storage unit 112 (step S31). The past data may be a processing result of the individual likelihood ratio calculation unit 111 for the element obtained one time before the element obtained this time by the data acquisition unit 50 (in other words, the individual likelihood ratio calculated for the previous element), for example. Alternatively, the past data may be the element itself obtained one time before the element obtained in the acquisition.

Subsequently, the individual likelihood ratio calculation unit 111 calculates a new individual likelihood ratio (i.e., the individual likelihood ratio for the element obtained this time by the data acquisition unit 50) on the basis of the element obtained by the data acquisition unit 50 and the past data read from the first storage unit 112 (step S32). The individual likelihood ratio calculation unit 111 outputs the calculated individual likelihood ratio to the second calculation unit 120. The individual likelihood ratio calculation unit 111 may store the calculated individual likelihood ratio in the first storage unit 112.

Subsequently, the integrated likelihood ratio calculation unit 121 of the second calculation unit 120 reads the past integrated likelihood ratio from the second storage unit 122 (step S33). The past integrated likelihood ratio may be a processing result of the integrated likelihood ratio calculation unit 121 for the element obtained one time before the element obtained this time by the data acquisition unit 50 (in other words, the integrated likelihood ratio calculated for the previous element), for example.

Subsequently, the integrated likelihood ratio calculation unit 121 calculates a new integrated likelihood ratio (i.e., the integrated likelihood ratio for the element obtained this time by the data acquisition unit 50) on the basis of the likelihood ratio calculated by the individual likelihood ratio calculation unit 111 and the past integrated likelihood ratio read from the second storage unit 122 (step S34). The integrated likelihood ratio calculation unit 121 outputs the calculated integrated likelihood ratio to the class classification unit 200. The integrated likelihood ratio calculation unit 121 may store the calculated integrated likelihood ratio in the second storage unit 122.

### <Flow of Learning Operation>

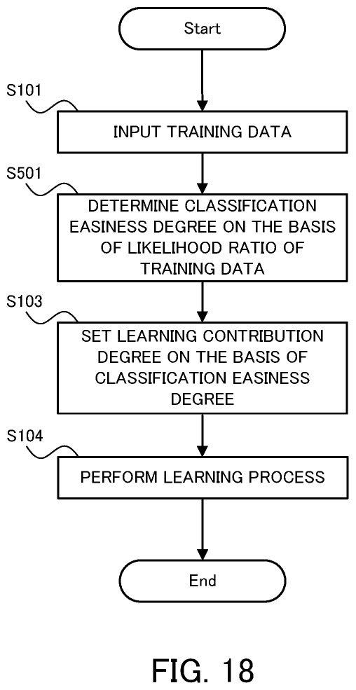

Next, a flow of operation of the learning unit 300 in the information processing system 1 according to the fifth example embodiment will be described with reference to FIG. 18. FIG. 18 is a flowchart illustrating the flow of the operation of the learning unit in the information processing system according to the fifth example embodiment. In FIG. 18, the same steps as those illustrated in FIG. 4 carry the same reference numerals.

As illustrated in FIG. 18, when the learning operation in the information processing system 1 according to the fifth example embodiment is started, first, the training data are inputted to the learning unit 300 (step S101).

Subsequently, especially in the fifth example embodiment, the learning unit 300 determines the classification easiness degree of the series data on the basis of the likelihood ratio calculated from the series data that are the training data (step S501). Specifically, the learning unit 300 determines the classification easiness degree of the series data on the basis of at least one of a time until the likelihood ratio reaches a correct answer threshold or an incorrect answer threshold, a slope of the likelihood ratio, and variance of the slope of the likelihood ratio. The likelihood ratio of the series data used to determine the classification easiness degree may be calculated in the learning operation, or may be calculated in advance before the learning operation is started.

Subsequently, the learning unit 300 sets the learning contribution degree of the series data on the basis of the determined classification easiness degree (step S103). Then, the learning unit 300 performs the learning process in view of the learning contribution degree (step S104).

### <Change in Likelihood Ratio>

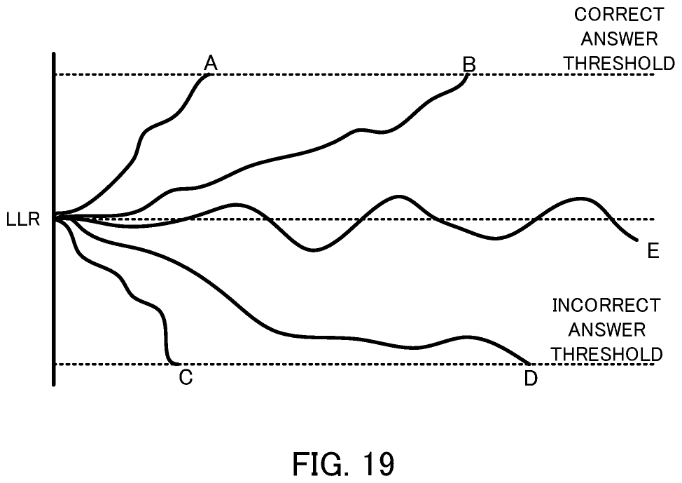

Next, a change in the likelihood ratio (specifically, the integrated likelihood ratio) calculated by the information processing system according to the fifth example embodiment will be specifically described with reference to FIG. 19. FIG. 19 is a graph illustrating an example of a likelihood ratio used for learning in the information processing system according to the fifth example embodiment.

As illustrated in FIG. 19, the likelihood ratio calculated by the likelihood ratio calculation unit 100 according to the fifth example embodiment (here, the log likelihood ratio: LLR) gradually varies over time by sequentially obtaining elements of the series data and repeatedly performing a calculation process. The five likelihood ratios A, B, C, D, and E in FIG. 18 are likelihood ratios corresponding to different series data.

The likelihood ratios A to E vary differently from one another. Specifically, the likelihood ratio A reaches the correct answer threshold (i.e., the threshold corresponding to the correct answer class) at a relatively early stage after the calculation process is started. The likelihood ratio B reaches the correct answer threshold at a relatively late stage after the calculation process starts (specifically, at a time later than that of the likelihood ratio A). The likelihood ratio C reaches the incorrect answer threshold (i.e., the threshold corresponding to an incorrect answer class other than the correct answer class) at a relatively early stage after the calculation process is started. The likelihood ratio D reaches the incorrect answer thresholds at a relatively late stage after the calculation process is started (specifically, at a time later than that of the likelihood ratio C). The likelihood ratio E does not reach either the correct answer threshold or the incorrect answer threshold after the calculation process is started.

The determination unit 310 of the learning unit 300 according to the fifth example embodiment determines the classification easiness degree on the basis of the change in the likelihood ratio described above. The determination unit 310 may determine the classification easiness degree on the basis of the time until the likelihood ratio reaches the correct answer threshold or the incorrect answer threshold, for example. As already described, both the likelihood ratios A and B illustrated in FIG. 18 reach the correct answer threshold, but have different arrival timing. Similarly, both the likelihood ratios C and D reach the incorrect answer threshold, but have different arrival timing. Such a difference in the timing of reaching the threshold can be considered to correspond to the ease of classification of each likelihood ratio. For example, since the likelihood ratio A reaches the correct answer threshold in relatively early timing, it can be determined that the series data are easy to classify. On the other hand, since the likelihood ratio C reaches the incorrect answer threshold in relatively early timing, it can be determined that the series data are hard to classify. The determination unit 310 may determine the classification easiness degree on the basis of the difference in the timing of reaching the threshold as described above. A more specific determination method will be described in detail in another example embodiment described later.

Alternatively, the determination unit 310 may determine the classification easiness degree on the basis of the slope of the likelihood ratio. For example, the likelihood ratio A has a slope to the correct answer threshold, and has a relatively large value of the slope. As a result, the likelihood ratio A reaches the correct answer threshold in relatively early timing. The likelihood ratio B has a slope to the correct answer threshold in the same manner as A, but has a relatively small value of the slope. As a result, the likelihood ratio B reaches the correct answer threshold in relatively late timing. On the other hand, the likelihood ratio C has a slope to the incorrect answer threshold, and has a relatively large value of the slope. As a result, the likelihood ratio C reaches the incorrect answer threshold in relatively early timing. The likelihood ratio D has a slope to the incorrect answer threshold in the same manner as C, but has a relatively small value of the slope. As a result, the likelihood ratio D reaches the incorrect answer threshold in relatively late timing Thus, the slope of the likelihood ratio is significantly related to the time required to reach the threshold. Therefore, the determination unit 310 is allowed to determine the classification easiness degree from the slope of the likelihood ratio, as in the case of using the time required to reach the threshold.

Alternatively, the determination unit 310 may determine the classification easiness degree on the basis of the variance (i.e., variation) of the slope of the likelihood ratio. The “variance of the slope” here means that a direction of the slope of the likelihood ratio changes many times in a direction of the correct answer threshold or in a direction of the incorrect answer threshold. For example, in the likelihood ratio E, the direction of the slope is reversed many times, and the variance of the slope is also large. As a result, the likelihood ratio E does not reach any of the correct answer threshold and the incorrect answer threshold. Thus, for a likelihood ratio with a large variance of the slope, it can be determined that the series data are hard to classify. On the other hand, a likelihood ratio with a small variance of the slope significantly varies in one direction, and thus, it can be determined that the series data are easy to classify. The handling of the likelihood ratio that does not reach any of the correct answer threshold and the incorrect answer threshold like the likelihood ratio E, will be described in detail in another example embodiment described later.

When the classification easiness degree is determined on the basis of the slope of the likelihood ratio and the variance of the slope of the likelihood ratio, the slope of the entire likelihood ratio or the variance of the slope of the entire likelihood ratio may be used, or the slope of a part of the likelihood ratio or the variance of the slope of a part of the likelihood ratio may be used. When the slope of the entire likelihood ratio or the variance of the slope of the entire likelihood ratio is used, for example, am average value of the slope or the variance of the slope may be obtained, and the classification easiness degree may be determined on the basis of the average value. When the classification easiness degree is determined from all the series data in this manner, it is sufficient to set the learning contribution degree for all the series data. On the other hand, when the slope of a part of the likelihood ratio or the variance of the slope of a part of the likelihood ratio is used, the classification easiness degree may be determined on the basis of the slope of the likelihood ratio or the variance of the slope of the likelihood ratio at any given timing. When the classification easiness degree is determined from only a part of the series data in this manner, it is sufficient to set the learning contribution degree for a part of the series data. Even in one series data, the learning contribution degree may be set differently depending on the part of the series data.

### (Technical Effect)

Next, a technical effect obtained by the information processing system 1 according to the fifth example embodiment will be described.

As described in FIG. 16 to FIG. 19, in the information processing system 1 according to the fifth example embodiment, the classification easiness degree is determined on the basis of the likelihood ratio calculated by the likelihood ratio calculation unit 100. In this way, even when the classification easiness degree of the series data is not known in advance, it is possible to determine and obtain the classification easiness degree from the likelihood ratio calculated from the series data. As a result, it is possible to properly set the learning contribution degree on the basis of the determined classification easiness degree.

### Sixth Example Embodiment

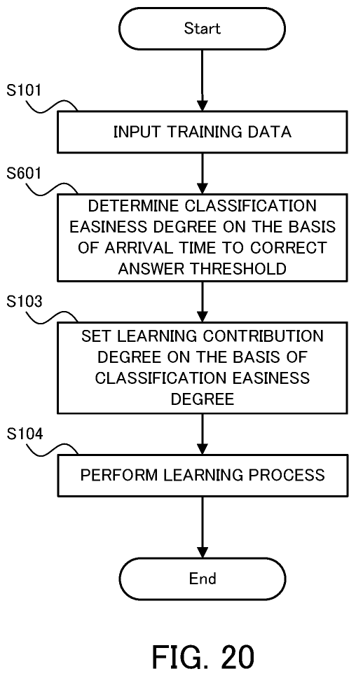

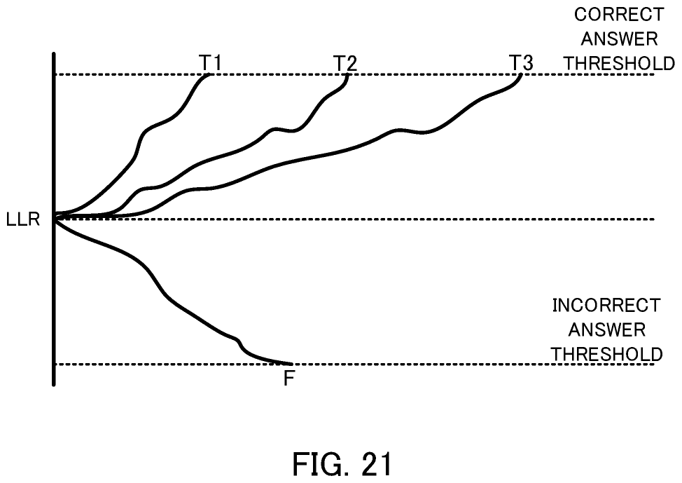

The information processing system 1 according to a sixth example embodiment will be described with reference to FIG. 20 and FIG. 21. Note that the sixth example embodiment describes a specific method of determining the classification easiness degree in the fifth example embodiment, and may be the same as the fifth example embodiment in the apparatus configuration and the flow of the operation. For this reason, a part that is different from each of the example embodiments described above will be described in detail below, and a description of other overlapping parts will be omitted as appropriate.

### <Flow of Learning Operation>

First, a flow of operation of the learning unit 300 in the information processing system 1 according to the sixth example embodiment will be described with reference to FIG. 20. FIG. 20 is a flowchart illustrating the flow of the operation of the learning unit in the information processing system according to the sixth example embodiment. In FIG. 20, the same steps as those illustrated in FIG. 18 carry the same reference numerals.

As illustrated in FIG. 20, when the learning operation in the information processing system 1 according to the sixth example embodiment is started, first, the training data are inputted to the learning unit 300 (step S101).

Subsequently, especially in the sixth example embodiment, the learning unit 300 determines the classification easiness degree of the series data on the basis of the time until the likelihood ratio calculated from the series data as the training data reaches the correct answer threshold (step S601). The likelihood ratio of the series data used to determine the classification easiness degree may be calculated in the learning operation, or may be calculated in advance before the learning operation is started. The time until the likelihood ratio reaches the correct answer threshold may also be calculated in the learning operation, or may be calculated in advance before the learning operation is started.

Subsequently, the learning unit 300 sets the learning contribution degree of the series data on the basis of the determined classification easiness degree (step S103). Then, the learning unit 300 performs the learning process in view of the learning contribution degree (step S104).

### <Specific Example of Determination>

Next, with reference to FIG. 21, a specific example of determination by the determination unit 310 according to the sixth example embodiment will be described. FIG. 21 is a graph illustrating an example of the likelihood ratio used for the learning in the information processing system according to the sixth example embodiment.

As illustrated in FIG. 21, it is assumed that there are likelihood ratios T1, T2 and T3 with different times required to reach the correct answer threshold. In such a case, it can be determined that the series data corresponding to the likelihood ratio with a shorter time required to reach the correct answer threshold, are easy to classify. Therefore, the determination unit 310 determines that the classification easiness degree is higher as the time required to reach the correct answer threshold is shorter. Specifically, the determination unit 310 determines that the classification easiness degree of the likelihood ratio T1 is the highest, the classification easiness degree of the likelihood ratio T2 is the second highest, and the classification easiness degree of the likelihood ratio T3 is the third highest.

Although FIG. 21 also illustrates a likelihood ratio F that reaches the incorrect answer threshold, it can be determined that the series data corresponding to the likelihood ratios T1, T2 and T3 that reach the correct answer threshold, are easier to classify than the series data corresponding to the likelihood ratio F. That is, the likelihood ratios T1, T2 and T3 are common in that the correct answer can be selected, even though their times required to reach the correct answer threshold are different, and it can be determined that the series data corresponding to the likelihood ratios T1, T2 and T3 are easier to classify than the series data corresponding to the likelihood ratio F in which the incorrect answer is selected. Therefore, the classification easiness degree of the series data corresponding to the likelihood ratios T1, T2, and T3 may be determined to be higher than the classification easiness degree of the series data corresponding to the likelihood ratio F.

### (Technical Effect)

Next, a technical effect obtained by the information processing system 1 according to the sixth example embodiment will be described.

As described in FIG. 20 and FIG. 21, in the information processing system 1 according to the sixth example embodiment, the classification easiness degree is determined on the basis of the time until the likelihood ratio reaches the correct answer threshold. In this way, it is possible to obtain the classification easiness degree of the series data that are the training data, easily and as a proper value. Therefore, it is possible to change the learning contribution degree in accordance with the classification easiness degree and to realize proper learning.

### Seventh Example Embodiment

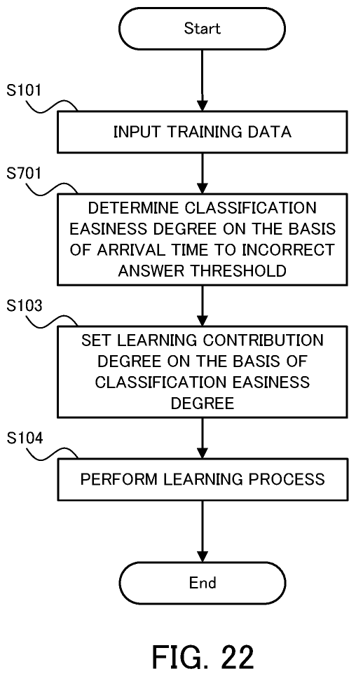

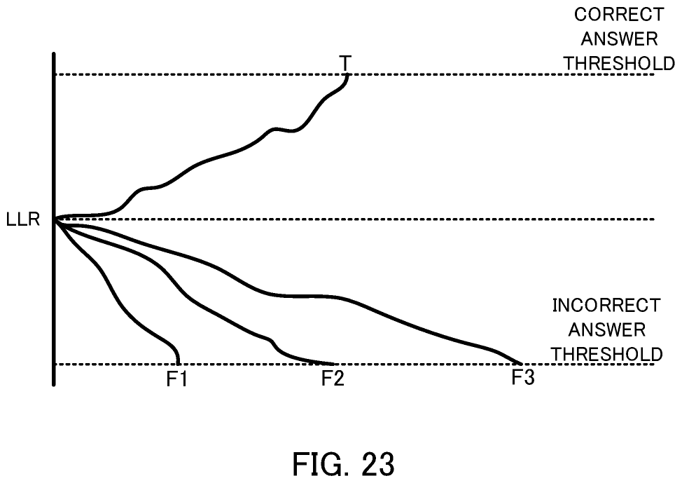

The information processing system 1 according to a seventh example embodiment will be described with reference to FIG. 22 and FIG. 23. The seventh example embodiment describes, as in the sixth example embodiment, a specific method of determining the classification easiness degree in the fifth example embodiment, and may be the same as fifth example embodiment in the apparatus configuration and the flow of the operation. For this reason, a part that is different from each of the example embodiments described above will be described in detail below, and a description of other overlapping parts will be omitted as appropriate.

### <Flow of Learning Operation>

First, a flow of operation of the learning unit 300 in the information processing system 1 according to the seventh example embodiment will be described with reference to FIG. 22. FIG. 22 is a flowchart illustrating the flow of the operation of the learning unit in the information processing system according to the seventh example embodiment. In FIG. 22, the same steps as those illustrated in FIG. 18 carry the same reference numerals.

As illustrated in FIG. 22, when the learning operation in the information processing system 1 according to the seventh example embodiment is started, first, the training data are inputted to the learning unit 300 (step S101).

Subsequently, especially in the seventh example embodiment, the learning unit 300 determines the classification easiness degree of the series data on the basis of the time until the likelihood ratio calculated from the series data that are the training data reaches the incorrect answer threshold (step S701). The likelihood ratio of the series data used to determine the classification easiness degree may be calculated in the learning operation, or may be calculated in advance before the learning operation is started. The time until the likelihood ratio reaches the incorrect answer threshold may also be calculated in the learning operation, or may be calculated in advance before the learning operation is started.

Subsequently, the learning unit 300 sets the learning contribution degree of the series data on the basis of the determined classification easiness degree (step S103). Then, the learning unit 300 performs the learning process in view of the learning contribution degree (step S104).

### <Specific Example of Determination>

Next, with reference to FIG. 23, a specific example of determination by the determination unit 310 according to the seventh example embodiment will be described. FIG. 23 is a graph illustrating an example of the likelihood ratio used for the learning in the information processing system according to the seventh example embodiment.

As illustrated in FIG. 23, it is assumed that there are likelihood ratios F1, F2 and F3 with different times required to reach the incorrect answer threshold. In such a case, it can be determined that the series data corresponding to the likelihood ratio with a shorter time required to reach the incorrect answer threshold, are hard to classify (in other words, the classification is easily mistakable). Therefore, the determination unit 310 determines that the classification easiness degree is lower as the time required to reach the incorrect answer threshold is shorter. Specifically, the determination unit 310 determines that the classification easiness degree of the likelihood ratio F1 is the lowest, the classification easiness degree of the likelihood ratio F2 is the second lowest, and the classification easiness degree of the likelihood ratio F3 is the third lowest.

Although FIG. 23 also illustrates the likelihood ratio T that reaches the correct answer threshold, it can be determined that the series data corresponding to the likelihood ratios F1, F2 and F3 that reach the incorrect answer threshold, are harder to classify than the series data corresponding to the likelihood ratio T. That is, the likelihood ratios F1, F2 and F3 are common in that the incorrect answer can be selected, even though their times required to reach the incorrect answer threshold are different, and it can be determined that the series data corresponding to the likelihood ratios F1, F2 and F3 are harder to classify than the series data corresponding to the likelihood ratio T in which the correct answer is selected. Therefore, the classification easiness degree of the series data corresponding to the likelihood ratios F1, F2 and F3 may be determined to be lower than the classification easiness degree of the series data corresponding to the likelihood ratio T.

### (Technical Effect)

Next, a technical effect obtained by the information processing system 1 according to the seventh example embodiment will be described.

As described in FIG. 22 and FIG. 23, in the information processing system 1 according to the seventh example embodiment, the classification easiness degree is determined on the basis of the time until the likelihood ratio reaches the incorrect answer threshold. In this way, it is possible to obtain the classification easiness degree of the series data that are the training data, easily and as a proper value. Therefore, it is possible to change the learning contribution degree in accordance with the classification easiness degree and to realize the proper learning.

### Eighth Example Embodiment

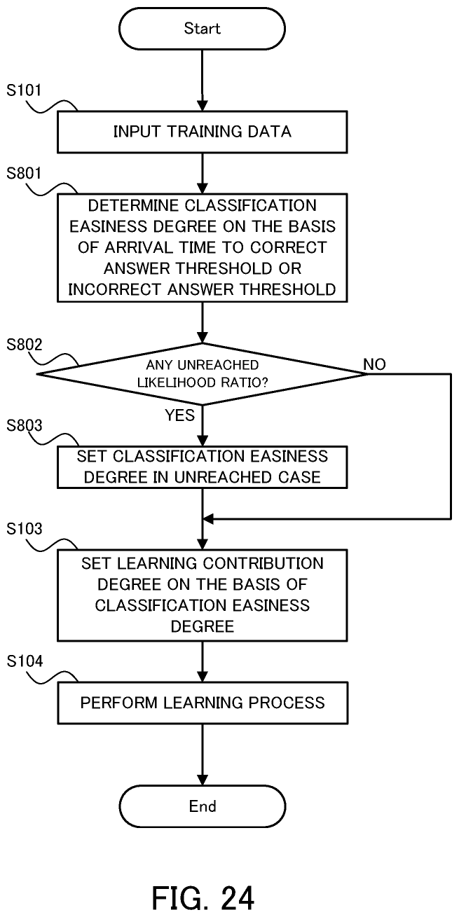

The information processing system 1 according to an eighth example embodiment will be described with reference to FIG. 24 to FIG. 26. The eighth example embodiment describes, as in the sixth and seventh example embodiments, a specific method of determining the classification easiness degree in the fifth example embodiment, and may be the same as the fifth example embodiment in the apparatus configuration and the flow of the operation. For this reason, a part that is different from each of the example embodiments described above will be described in detail below, and a description of other overlapping parts will be omitted as appropriate.

### <Flow of Learning Operation>

First, a flow of operation of the learning unit 300 in the information processing system 1 according to the eighth example embodiment will be described with reference to FIG. 24. FIG. 24 is a flowchart illustrating the flow of the operation of the learning unit in the information processing system according to the eighth example embodiment. In FIG. 24, the same steps as those illustrated in FIG. 18 carry the same reference numerals.

As illustrated in FIG. 24, when the learning operation in the information processing system 1 according to the eighth example embodiment is started, first, the training data are inputted to the learning unit 300 (step S101).

Subsequently, especially in the eighth example embodiment, the learning unit 300 determines the classification easiness degree of the series data on the basis of the time until the likelihood ratio calculated from the series data that is the training data reaches the correct answer threshold or the incorrect answer threshold (step S801). That is, as described in the sixth example embodiment (see FIG. 20) and the seventh example embodiment (see FIG. 22), it is determined that the classification easiness degree is higher as the time required to reach the correct answer threshold shorter, and that the classification easiness degree is lower as the time required to reach the incorrect answer threshold is shorter.

Subsequently, the learning unit 300 determines whether or not there is any likelihood ratio that does not reach any of the correct answer threshold and the incorrect answer threshold (step S802). This determination process may be performed at a time when a predetermined time elapses after the process of calculating the likelihood ratio is started, for example. The “predetermined time” here is a time set as an upper limit of a time for performing the likelihood ratio calculation process. Therefore, after a lapse of the predetermined period, the process of calculating the likelihood ratio is stopped even when the likelihood ratio does not reach any of the correct answer threshold and the incorrect answer threshold. Then, the likelihood ratio that does not reach any of the correct answer threshold and the incorrect answer threshold is treated as “unreached”.

If there is an unreached likelihood ratio (step S802: YES), the determination unit 310 sets a predetermined classification easiness degree for the series data corresponding to the unreached likelihood ratio. Specifically, the classification easiness degree of the series data corresponding to the unreached likelihood ratio is set to be lower than the classification easiness degree of the series data corresponding to the likelihood ratio reaches the correct answer threshold and to be higher than the classification easiness degree of the series data corresponding to the likelihood ratio that reaches the incorrect answer threshold. A more specific method of setting the classification easiness degree will be described in detail with specific examples later.

Subsequently, the learning unit 300 sets the learning contribution degree of the series data on the basis of the determined classification easiness degree (step S103). Then, the learning unit 300 performs the learning process in view of the learning contribution degree (step S104).

### <Specific Example of Determination>

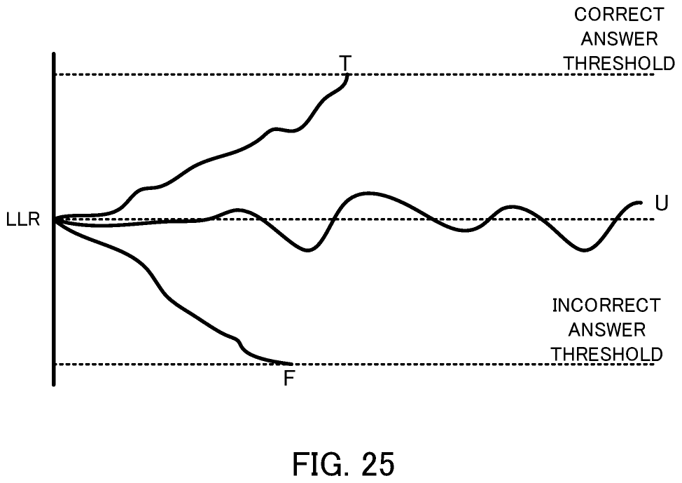

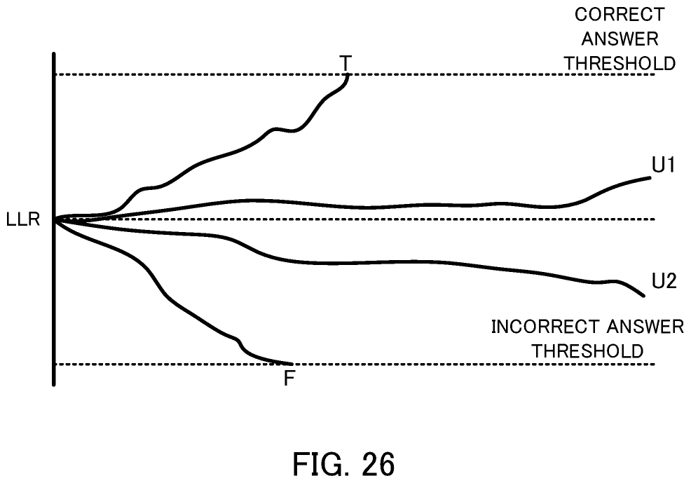

Next, with reference to FIGS. 25 and 26, specific examples of determination by the determination unit 310 according to the eighth example embodiment will be described. FIG. 25 is version 1 of a graph illustrating an example of the likelihood ratio used for the learning in the information processing system according to the eighth example embodiment. FIG. 26 is version 2 of a graph illustrating an example of the likelihood ratio used for the learning in the information processing system according to the eighth example embodiment.

As illustrated in FIG. 25, it is assumed that there are the likelihood ratio T that reaches the correct answer threshold, the likelihood ratio F that reaches the incorrect answer threshold, and a likelihood ratio U that does not reach any of the correct answer threshold and the incorrect answer threshold. In such a case, since the correct answer cannot be selected in the likelihood ratio U that does not reach any of the correct answer threshold and the incorrect answer threshold, it can be determined that the series data corresponding to the likelihood ratio U are harder to classify than the series data corresponding to the likelihood ratio T that reaches the correct answer threshold. Therefore, the determination unit 310 determines that the classification easiness degree of likelihood ratio U is lower than the classification easiness degree of likelihood ratio T. On the other hand, since the incorrect answer is not selected (i.e., a wrong selection is not made) in the likelihood ratio U that does not reach any of the correct answer threshold and the incorrect answer threshold, it can be determined that the series data corresponding to the likelihood ratio U are easier to classify than the series data corresponding to the likelihood ratio F that reaches the incorrect answer threshold. Therefore, the determination unit 310 determines that the classification easiness degree of likelihood ratio U is higher than the classification easiness degree of likelihood ratio F.

As illustrated in FIG. 26, it is assumed there are the likelihood ratio T that reaches the correct answer threshold, the likelihood ratio F that reaches the incorrect answer threshold, and likelihood ratios U1 and U2 that do not reach any of the correct answer threshold and the incorrect answer threshold. In such a case, when the likelihood ratios U1 and U2 that do not reach any of the correct answer threshold and the incorrect answer threshold are compared, a value of the likelihood ratio U1 is eventually close to the correct answer threshold, while the value of the likelihood ratio U2 is eventually close to the incorrect answer threshold. Therefore, it can be determined that the likelihood ratio U1 is close to the correct answer, in comparison with the likelihood ratio U2. Conversely, it can be determined that the likelihood ratio U2 is closer to the incorrect answer, in comparison with the likelihood ratio U1. Therefore, the determination unit 310 determines that the classification easiness degree of likelihood ratio U1 is higher than the classification easiness degree of likelihood ratio U2. Including the other likelihood ratios, the determination unit 310 determines that the classification easiness degree of the likelihood ratio T that reaches the correct answer threshold is the highest, the classification easiness degree of the unreached likelihood ratio U1 that is close to the correct answer is the second highest, the classification easiness degree of the unreached likelihood ratio U2 that is close to the incorrect answer is the third highest, and the likelihood ratio F that reaches the incorrect answer threshold is the fourth highest.

### (Technical Effect)

Next, a technical effect obtained by the information processing system 1 according to the eighth example embodiment will be described.

As described in FIGS. 24 to 26, in the information processing system 1 according to the eighth example embodiment, the classification easiness degree is determined even for the unreached likelihood ratio that does not reach any of the correct answer threshold and the incorrect answer threshold. In this way, it is possible to obtain the classification easiness degree of the series data that are the training data, easily and as a proper value. Therefore, it is possible to change the learning contribution degree in accordance with the classification easiness degree and to realize the proper learning.

### Ninth Example Embodiment

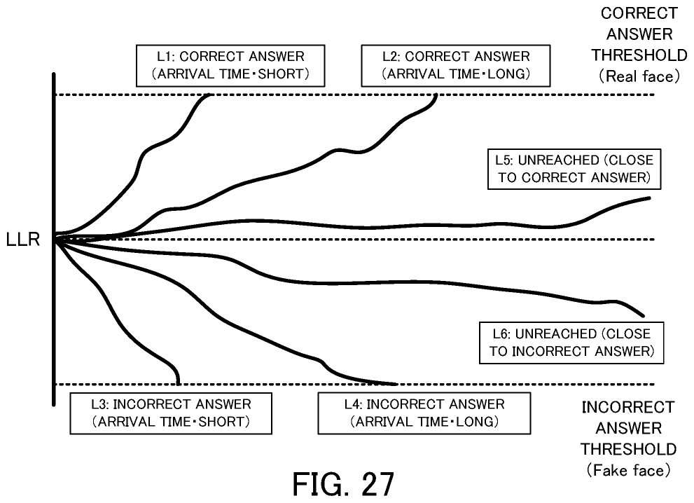

The information processing system 1 according to a ninth example embodiment will be described with reference to FIG. 27. The ninth example embodiment describes a specific example when the information processing system 1 according to the first to the eight example embodiments is applied to biometric determination, and may be the same as the first to eighth example embodiments in the configuration and the operation. For this reason, a part that is different from each of the example embodiments described above will be described in detail below, and a description of other overlapping parts will be omitted as appropriate.

### (Biometric Determination)

The information processing system 1 according to the ninth example embodiment is applied to a biometric determination system that is configured to determine whether an imaged face is a real face (i.e., a face of a living body) or a fake face (e.g., a face other than the face of a living body, caused by a photograph, a mask, or the like). In this case, in the information processing system 1 according to the ninth example embodiment, for example, a video that captures a face image of a person is inputted as the series data. The data acquisition unit 50 obtains a plurality of image frames included in the video, as elements included in the series data. The likelihood ratio calculation unit 100 calculates a likelihood ratio indicating a likelihood that the face captured from a plurality of images is a real face. Then, the class classification unit 200 classifies whether the captured face is a real face or a fake face, on the basis of the calculated likelihood ratio.

### (Handling of Likelihood Ratio in Learning Operation)

Next, with reference to FIG. 27, a learning operation in the biometric determination system will be described. FIG. 27 is a graph illustrating an example of the likelihood ratio used for the learning in the information processing system according to the ninth example embodiment. It is assumed that each likelihood ratio illustrated in FIG. 27 is a likelihood ratio calculated from a video that captures a real face (i.e., the series data in which the “real face” is a correct answer).

As illustrated in FIG. 27, it is assumed that likelihood ratios L1, L2, L3, L4, L5 and L6 are calculated respectively from the videos inputted as the training data. The likelihood ratio L1 reaches the correct answer threshold and it takes a relatively short time to reach it. The likelihood ratio L2 reaches the correct answer threshold and it takes a relatively long time to reach it. The likelihood ratio L3 reaches the incorrect answer threshold and it takes a relatively short time to reach it. The likelihood ratio L4 reaches the incorrect answer threshold and it takes a relatively long time to reach it. The likelihood ratio L5 does not reach any of the correct answer threshold and the incorrect answer threshold, and it eventually has a value that is close to the correct answer. The likelihood ratio L6 does not reach any of the correct answer threshold and the incorrect answer threshold, and it eventually has a value that is close to the incorrect answer.

In the likelihood ratios L1 to L6, for example, as described in the sixth to eighth example embodiments (e.g., see FIG. 20 to FIG. 26), it is possible to determine the classification easiness degree by using the time until the likelihood ratio reaches the correct answer threshold or the incorrect answer threshold, and a final value in the unreached case (that is close to the correct answer or is close to the incorrect answer). Specifically, it is determined that the classification easiness degree is high in the order of the likelihood ratio L1, the likelihood ratio L2, the likelihood ratio L5, the likelihood ratio L6, the likelihood ratio L4, and the likelihood ratio L3. As described in the fifth example embodiment, the classification easiness degree may be determined on the basis of the slope of the likelihood ratio, or the variance of the slope of the likelihood ratio.

As described above, if the classification easiness degree is determined from the likelihood ratio, it is possible to set the learning contribution from the determined classification easiness degree. Therefore, it is possible to change the influence on the learning in accordance with the ease of classification of the likelihood ratio and to perform more proper learning. Specifically, the learning is performed by lowering the learning contribution degree of the series data that are easy to classify (e.g., the data that allows easy determination of a real face), and by increasing the learning contribution degree of the series data that are hard to classify (e.g., the data that hardly allows determination of a real face). As a result, in the biometric determination system to which the information processing system 1 according to the ninth example embodiment is applied, it is possible to accurately determine a real face and a fake face.

A processing method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. An information processing apparatus, an information processing method, and a computer program with such changes are also intended to be within the technical scope of this disclosure.

### <Supplementary Notes>

The example embodiments described above may be further described as, but not limited to, the following Supplementary Notes below.

### (Supplementary Note 1)

An information processing system described in Supplementary Note 1 is an information processing system including: an acquisition unit that obtains a plurality of elements included in series data; a calculation unit that calculates a likelihood ratio indicating a likelihood of a class to which the series data belong, on the basis of at least two consecutive elements of the plurality of elements: a classification unit that classifies the series data into at least one class, on the basis of the likelihood ratio; and a learning unit that performs learning related to calculation of the likelihood ratio, by using a plurality of series data, wherein the learning unit changes a degree of contribution to the learning of each of the plurality of series data in accordance with ease of classification of the series data.

### (Supplementary Note 2)

An information processing system described in Supplementary Note 2 is the information processing system described in Supplementary Note 1, wherein the learning unit lowers the degree of contribution of the series data that are easy to classify, and increases the degree of contribution of the series data that are hard to classify.

### (Supplementary Note 3)

An information processing system described in Supplementary Note 3 is the information processing system described in Supplementary Note 1 or 2, wherein the learning unit ranks the plurality of series data in accordance with the ease of classification, and determines the degree of contribution on the basis of a rank.

### (Supplementary Note 4)

An information processing system described in Supplementary Note 4, wherein the learning unit is the information processing system described in any one of Supplementary Notes 1 to 3, wherein the learning unit includes a determination unit that determines the ease of classification of the series data on the basis of at least one of a time until the likelihood ratio reaches a predetermined threshold corresponding to each of classes of classification candidates, a slope of the likelihood ratio, and variance of the slope of the likelihood ratio.

### (Supplementary Note 5)

An information processing system described in Supplementary Note 5 is the information processing system described in Supplementary Note 4, wherein the determination unit determines that the series data are easier to classify as the time until the likelihood ratio reaches a first predetermined threshold corresponding to a correct answer class is shorter, and determines that the series data are harder to classify as the time until the likelihood ratio reaches a second predetermined threshold corresponding to an incorrect answer class is shorter.

### (Supplementary Note 6)

An information processing system described in Supplementary Note 6 is the information processing system described in Supplementary Note 4 or 5, wherein the determination unit determines that the series data are easier to classify as the slope is larger until the likelihood ratio reaches the first predetermined threshold corresponding to the correct answer class, and determines that the series data are harder to classify as the slope is smaller until the likelihood ratio reaches the second predetermined person threshold corresponding to the incorrect answer class.

### (Supplementary Note 7)

An information processing system described in Supplementary Note 7 is the information processing system described in any one of Supplementary Notes 4 to 6, wherein the determination unit determines that the series data are harder to classify as the variance of the slope is larger until the likelihood ratio reaches the first predetermined threshold corresponding to the correct answer class, and determines that the series data are easier to classify as the variance of the slope is smaller until the likelihood ratio reaches the second predetermined person threshold corresponding to the incorrect answer class.

### (Supplementary Note 8)

An information processing system described in Supplementary Note 8 is the information processing system described in any one of Supplementary Notes 4 to 7, wherein the determination unit determines that the series data in which the likelihood ratio does not reach any of the first predetermined threshold corresponding to the correct answer class and the second predetermined threshold corresponding to the incorrect answer class within a predetermined time, are harder to classify than the series data in which the likelihood ratio reaches the first predetermined threshold, and are easier to classify than the series data in which the likelihood ratio reaches the second predetermined threshold.

### (Supplementary Note 9)

An information processing method described in Supplementary Note 9 is an information processing method including: obtaining a plurality of elements included in series data; calculating a likelihood ratio indicating a likelihood of a class to which the series data belong, on the basis of at least two consecutive elements of the plurality of elements: classifying the series data into at least one class, on the basis of the likelihood ratio; performing learning related to calculation of the likelihood ratio, by using a plurality of series data; and when performing the learning, changing a degree of contribution to the learning of each of the plurality of series data in accordance with ease of classification of the series data.

### (Supplementary Note 10)

A computer program described in Supplementary Note 10 is a computer program that operates a computer: to obtain a plurality of elements included in series data; to calculate a likelihood ratio indicating a likelihood of a class to which the series data belong, on the basis of at least two consecutive elements of the plurality of elements: to classify the series data into at least one class, on the basis of the likelihood ratio; to perform learning related to calculation of the likelihood ratio, by using a plurality of series data; and when performing the learning, to change a degree of contribution to the learning of each of the plurality of series data in accordance with ease of classification of the series data.

### (Supplementary Note 11)

A recording medium described in Supplementary Note 11 is a recording medium on which the computer program described in Supplementary Note 10 is recorded.

### DESCRIPTION OF REFERENCE CODES

1 Information processing system
11 Processor
14 Storage apparatus
10 Classification apparatus
50 Data acquisition unit
100 Likelihood ratio calculation unit
110 First calculation unit
111 Individual likelihood ratio calculation unit
112 First storage unit
120 Second calculation unit
121 Integrated likelihood ratio calculation unit
122 Second storage unit
200 Class classification unit
300 Learning unit
310 Determination unit

What is claimed is:

1. An information processing system comprising:
at least one memory that is configured to store instructions; and
at least one processor that is configured to execute the instructions to
obtain a plurality of elements included in series data;
calculate a likelihood ratio indicating a likelihood of a class to which the series data belong, on the basis of at least two consecutive elements of the plurality of elements:
classify the series data into at least one class, on the basis of the likelihood ratio;
perform learning related to calculation of the likelihood ratio, by using a plurality of series data; and
change a degree of contribution to the learning of each of the plurality of series data in accordance with ease of classification of the series data.

2. The information processing system according to claim 1, wherein the at least one processor is configured to execute the instructions to decrease the degree of contribution of the series data that are easy to classify, and increase the degree of contribution of the series data that are hard to classify.

3. The information processing system according to claim 1, wherein the at least one processor is configured to execute the instructions to rank the plurality of series data in accordance with the ease of classification, and determine the degree of contribution on the basis of rank.

4. The information processing system according to claim 1, wherein the at least one processor is configured to execute the instructions to determine the ease of classification of the series data on the basis of at least one of a time until the likelihood ratio reaches a predetermined threshold corresponding to each of classes of classification candidates, a slope of the likelihood ratio, and variance of the slope of the likelihood ratio.

5. The information processing system according to claim 4, wherein the at least one processor is configured to execute the instructions to determine that the series data are easier to classify as the time until the likelihood ratio reaches a first predetermined threshold corresponding to a correct answer class is shorter, and determine that the series data are harder to classify as the time until the likelihood ratio reaches a second predetermined threshold corresponding to an incorrect answer class is shorter.

6. The information processing system according to claim 4, wherein the at least one processor is configured to execute the instructions to determine that the series data are easier to classify as the slope is larger until the likelihood ratio reaches the first predetermined threshold corresponding to the correct answer class, and determine that the series data are harder to classify as the slope is smaller until the likelihood ratio reaches the second predetermined person threshold corresponding to the incorrect answer class.

7. The information processing system according to claim 4, wherein the at least one processor is configured to execute the instructions to determine that the series data are harder to classify as the variance of the slope is larger until the likelihood ratio reaches the first predetermined threshold corresponding to the correct answer class, and determine that the series data are easier to classify as the variance of the slope is smaller until the likelihood ratio reaches the second predetermined person threshold corresponding to the incorrect answer class.

8. The information processing system according to claim 4, wherein the at least one processor is configured to execute the instructions to determine that the series data in which the likelihood ratio does not reach any of the first predetermined threshold corresponding to the correct answer class and the second predetermined threshold corresponding to the incorrect answer class within a predetermined time, are harder to classify than the series data in which the likelihood ratio reaches the first predetermined threshold, and are easier to classify than the series data in which the likelihood ratio reaches the second predetermined threshold.

9. An information processing method comprising:
obtaining a plurality of elements included in series data;
calculating a likelihood ratio indicating a likelihood of a class to which the series data belong, on the basis of at least two consecutive elements of the plurality of elements:
classifying the series data into at least one class, on the basis of the likelihood ratio;
performing learning related to calculation of the likelihood ratio, by using a plurality of series data; and
when performing the learning, changing a degree of contribution to the learning of each of the plurality of series data in accordance with ease of classification of the series data.

10. A non-transitory recording medium on which a computer program that allows a computer to execute an information processing method is recorded, the information processing method including:
obtaining a plurality of elements included in series data;
calculating a likelihood ratio indicating a likelihood of a class to which the series data belong, on the basis of at least two consecutive elements of the plurality of elements:
classifying the series data into at least one class, on the basis of the likelihood ratio;
performing learning related to calculation of the likelihood ratio, by using a plurality of series data; and
when performing the learning, changing a degree of contribution to the learning of each of the plurality of series data in accordance with ease of classification of the series data.
